(19) United States
(12) Patent Application Publication
(10) Pub. No.: US 2025/0299511 A1
(43) Pub. Date: Sep. 25, 2025

(54) GENERATING AND APPLYING A FONT GENOME TO INFORM FONT SELECTION

(71) Applicant: Monotype Imaging Inc., Woburn, MA (US)

(72) Inventors: Jon Eric von Gillern, West Des Moines, IA (US); Avinash Thakur, Ghaziabad (IN); Mohit Gupta, Delhi (IN); Neeraj Gulati, Gurgaon (IN)

(21) Appl. No.: 19/090,040

(22) Filed: Mar. 25, 2025

Related U.S. Application Data
(60) Provisional application No. 63/569,596, filed on Mar. 25, 2024.

(51) Int. Cl. G06V 30/32; G06F 40/109; G06T 11/20

(52) U.S. Cl. CPC G06V 30/36; G06F 40/109; G06T 11/203

(57) ABSTRACT

Methods, systems, and apparatus, including computer programs encoded on a computer storage medium, for processing each character glyph in a font to generate characterization data for the font. In one aspect, a system comprises a method for determining characterization data for a set of character glyphs of a first font, wherein the characterization data represents one or more stroke attributes indicative of using numerical control to render each stroke of the character glyph, and using the characterization data to inform available font options for font selection.

### CROSS-REFERENCE TO RELATED APPLICATION

This application claims the benefit of U.S. Provisional Application No. 63/569,596, filed on Mar. 25, 2024, the contents of which are incorporated by reference herein.

### BACKGROUND

This description relates to using fonts to render textual content. Fonts prescribe a particular style for each character in a set of characters. Each style can be represented using multiple quantities.

### SUMMARY

This specification describes a system implemented as one or more computer programs executable on one or more computers (in one or more locations) that can process each character glyph in a font to generate characterization data for the font. In particular, the system can determine characterization data for a number of fonts, e.g., Times New Roman, Arial, Comic Sans, or font styles, e.g., Calibri, Calibri Light, Calibri Bold, and aggregate the determined characterization data into a font genome.

According to a first aspect there is provided a method for determining characterization data for a set of character glyphs in a font, wherein the characterization data comprises stroke attributes indicative of using numerical control to render each stroke of the character glyph, and using the characterization data to inform available font options for font selection.

In an example, the method further includes determining characterization data for a plurality of fonts, and generating a font genome by aggregating the determined characterization data for the plurality of fonts and the determined characterization for the set of character glyphs of the first font.

In an example, determining characterization data includes defining one or more keypoints for each character glyph, and characterizing one or more strokes by determining a set of attributes for each keypoint using an image classification model.

In an example, defining the one or more keypoints for each character glyph includes processing each character glyph using an image correspondence model to determine the one or more keypoints.

In an example, the one or more keypoints determined by the image correspondence model are generalizable.

In an example, defining the one or more keypoints for each character glyph includes identifying a bounding box relative to a cardinal direction on the character glyph, advancing in a direction from a selected point along a contour of each stroke in a set of strokes in the bounding box until one or more criteria are met, and defining the one or more key points in accordance with the criteria each contour of each stroke meets in the bounding box.

In an example, the one or more criteria met comprise one or more of width, angle, or rate of change criteria.

In an example, the method further includes measuring an angle of each contour of each stroke relative to a closest perpendicular stroke to the contour.

In an example, the method further includes grouping character glyphs into logical groups based on the determined stroke attributes.

In an example, the method further includes evaluating a measure of distance between the defined one or more keypoints.

In an example, using the characterization data to inform available font options for font selection further comprises using the characterization data to inform search engine results.

In an example, using the characterization data to inform available font options for font selection further comprises conditioning a machine learning model for font selection using embeddings of the characterization data.

In an example, using the characterization data to inform available font options for font selection further comprises conditioning a generative machine learning model to generate fonts using the embeddings of the characterization data.

In one general aspect, a method is performed by a server. The method includes: receiving data representing an input character glyph associated with a particular font; generating first spacing data indicative of a spacing proximate to the input character glyph associated with the particular font; generating first image data comprising the data representing the input character glyph associated with the particular font and the generated first spacing data; generating second spacing data indicative of a spacing proximate to the input character glyph in the generated first image data; providing, as input to a machine learning model, the generated first image data and the generated second spacing data; obtaining, as output from the machine learning model, second image data of a set of output character glyphs associated with the particular font; generating a vector format of the obtained second image data of the set of output character glyphs; extracting the second spacing data from the generated vector format of the set of output character glyphs; scaling the generated vector format to match to a form of the data representing the input character glyph; and providing the scaled vector format of the set of output character glyphs for output, wherein the scaled vector format comprises the set of output character glyphs associated with the particular font.

Other embodiments of this and other aspects of the disclosure include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The foregoing and other embodiments can each optionally include one or more of the following features, alone or in combination. For example, one embodiment includes all the following features in combination.

In some implementations, receiving the data representing the input character glyph associated with the particular font includes receiving, from a database, font genome data for one or more character glyphs associated with the particular font, wherein the font genome data comprises characterization data for each of the one or more character glyphs.

In some implementations, further including receiving second data representing a subset of input character glyphs associated with the particular font, wherein a number of character glyphs in the subset of input character glyphs is less than a number of character glyphs in the set of output character glyphs associated with the particular font.

In some implementations, wherein generating the first spacing data indicative of the spacing proximate to the input character glyph of the particular font includes: generating left-side bearing spacing information that comprises spacing information to a left side of the input character glyph of the particular font; and generating right-side bearing spacing information that comprises spacing information to a right side of the input character glyph of the particular font.

In some implementations, wherein generating the second spacing data indicative of the spacing proximate to the input character glyph in the generated first image data includes adding one or more of pixels, lines, or metadata indicative of spacing to the generated first image data.

In some implementations, wherein providing, as input to the machine learning model, the generated first image data and the generated second spacing data includes providing, as input to a stable diffusion model, the generated first image data and the generated second spacing data.

In some implementations, wherein extracting the second spacing data from the generated vector format of the set of output character glyphs includes removing one or more of pixels, lines, or metadata indicative of spacing from the generated vector format of the set of output character glyphs.

In some implementations, wherein obtaining, as the output from the machine learning model, the second image data of the set of output character glyphs associated with the particular font includes generating the second image data of the set of output character glyphs associated with the particular font as a prediction based on the data representing the input character glyph associated with the particular font, wherein the set of output character glyphs with the particular font represent each glyph of an alphabet.

In some implementations, in response to providing the scaled vector format of the set of output character glyphs for output, receiving feedback on an output character glyph from the set of output character glyphs, wherein the feedback indicates a request to reprocess the output character glyph.

In some implementations, in response to receiving the feedback on one or more of the output character glyphs, the method further includes: receiving a set of reference images with a set of characters associated with the particular font; receiving a first source image comprising the output character glyph to be reprocessed; generating, using a first encoder, a first embedding using the received set of reference images; generating, using a second encoder, a second embedding using the received first image; generating a third embedding using the first embedding and the second embedding; providing, as input to a generative machine learning model, the third embedding; obtaining, from the generative machine learning model, an image representative of the third embedding; converting the output image to a fourth embedding; and generating, using a decoder that processed the fourth embedding, an output image that includes the output character glyph associated with the particular font.

Particular embodiments of the subject matter described in this specification can be implemented so as to realize one or more of the following advantages.

The methods of this specification enable for precise characterization of fonts by using a vector space of a font renderer directly to characterize the font instead of relying upon raster, e.g., grid-based data, which can be lower-resolution. By characterizing each character glyph of a font in vector space, the system is able to leverage scalable graphics, e.g., Bezier curves, to provide exact values for each stroke attribute. The system can determine precise font characterization data for a number of fonts and aggregate the data into an organized font genome that can provide high-resolution font characterization data for any subset of fonts in the genome, e.g., for use in downstream methods including customized search results and font selection.

In particular, the font genome can be used to condition a font generation model, e.g., a generative machine learning model, which has been configured to generate fonts. Using the font genome to condition the font generation model, e.g., instead of trying to learn to generate fonts from scratch, can allow the model to produce more realistic and stylistically accurate character glyphs than other models. More specifically, using the high-resolution characterization data of the font genome can overcome unwanted font characteristic effects due to regression to the mean, e.g., the mean provided by a font training set, relative to other methods that rely on training by dropping out existent character glyphs, e.g., from the font training set. As an example, another method that trains on shorter capitalization heights, e.g., 500 units, can generate a 600 unit capitalization height output when a 700 unit output is desired, while the method as described can generate the desired output height through conditioning.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram illustrating examples of fonts utilized to condition models.

FIG. 2 is a block diagram illustrating examples of different strokes utilize to create a character.

FIGS. 3-4 are block diagrams illustrating examples of measuring characteristics of a glyph.

FIG. 5-9 are block diagrams illustrating examples of fonts analyzed using automatic keypoint detection.

FIG. 10 is a block diagram illustrating an example of a generative adversarial network.

FIG. 11 is a block diagram illustrating an example of a stable diffusion model.

FIG. 12 is a block diagram illustrating steps of processing an image using generative artificial intelligence.

FIG. 13 is a block diagram illustrating an example of a generative artificial intelligence model creating different font outputs from a ground truth font.

FIG. 14 is a block diagram illustrating a creation of different glyphs for a desired font.

FIG. 15 is a diagram illustrating a glyph in a desired font.

FIG. 16 is a diagram illustrating training data for a genome.

FIG. 17 is a diagram illustrating example ground truths and corresponding generated glyphs created from the generative artificial intelligence model.

FIG. 18 is a block diagram that illustrates a generative artificial intelligence training and inference pipeline.

FIG. 19 is a block diagram that illustrates an example of a system for generating new fonts using few-shot learning.

FIG. 20 is a block diagram that illustrates an example of a system that utilizes artificial intelligence techniques to generate new fonts based on input characters.

FIG. 21 is a block diagram that illustrates an example of a flow chart that illustrates a creation of a new font from a target font.

FIG. 22 is a flow diagram that illustrates an example of a process for determining a font genome dataset.

Like reference numbers and designations in the various drawings indicate like elements. The components shown here, their connections and relationships, and their functions, are meant to be examples only, and are not meant to limit the implementations described and/or claimed in this document.

### DETAILED DESCRIPTION

In this specification, a font genome refers to a collection of character glyph characterization data that can be organized by font in order to provide representative data for each font. For example, the representative data can include stroke attributes that are indicative of how a font renderer uses numerical control to draw each stroke of the character glyph. The characterization data can be generated by processing each character glyph in the font and defining keypoints that can be used to determine a set of attributes, e.g., based on each keypoint.

In particular, keypoints can be defined to characterize each stroke of a character glyph. As an example, a terminal keypoint can define where one stroke ends, a join keypoint can define where the ends of two strokes come together, and a meet keypoint can define where the end of one stroke ends in the middle of another stroke. As another example, a waypoint keypoint can define a middle portion of a continuous stroke, a cross keypoint can define where two strokes meet while continuing in separate directions, and a tittle keypoint can define the small dot on a lowercase i and j glyph.

The font genome can serve as a unified repository of font data that can be used to inform available font options and font selection. For example, the font genome can be used to customize search engine results, e.g., in order to provide a user with more specific means of filtering and identifying a font for a particular use case. As another example, the font genome can be used to condition a font selection model or a font generation model, e.g., using embeddings of the characterization data.

In the case of font generation, the system can receive font genome data for a subset of character glyphs in a font (e.g., the embeddings of characterization data) and can condition a generative machine learning model as the font generation model using the font genome data. The system can then generate a font comprising a set of character glyphs not in the subset of character glyphs in the font, e.g., a set of new character glyphs that fit the overall style of the processed subset of character glyphs. In particular, a user can specify a style for a subset of character glyphs in a desired font, and the system can determine characterization data for the font that can be used to condition the font generation model in order to generate the other character glyphs of the font.

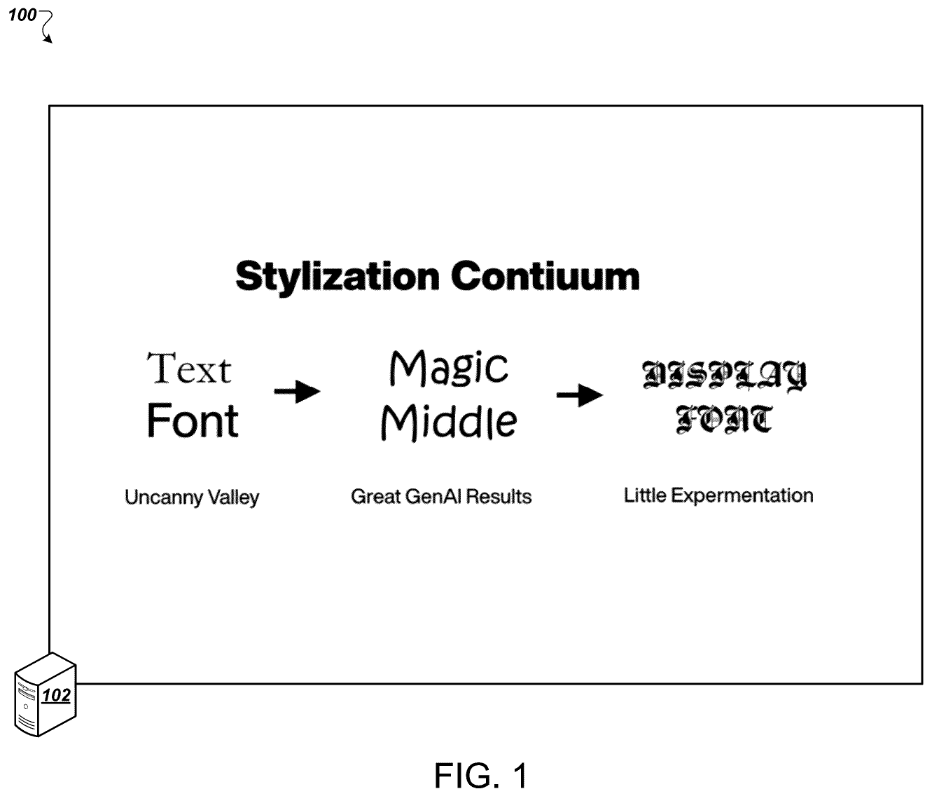

FIG. 1 is a block diagram illustrating examples of fonts 100 utilized to condition models. A server 102 can process glyphs of different fonts 100. In some cases, the server 102 can receive font genome data for a subset of character glyphs in a particular font and can condition a generative machine learning model. Using the conditioned generative machine learning, the server 102 can then generate a font, such as one of the fonts 100, that includes a set of character glyphs not in the subset of character glyphs. The server 102 can perform this process for a variety of different fonts 100.

In some implementations, the server 102 can include one or more computers. The one or more computers can operate collectively over a local network or over the Internet. In some cases, the server 102 can retrieve the font genome data for a subset of character glyphs in a font from a database or from a user that provided the character glyphs.

In some cases, training the generative machine learning model on typical text-image pairs, can often lead to passable results. This is often true for fonts that were produced by the generative machine learning model in the middle between a textual font, e.g., a font commonly used for user consumption of a text, e.g., in a blog, book, or newspaper, and a display font, e.g., a more ornamental font that may not adhere to the typical skeletal form of an individual letter, such as scripts or stylized fonts. In these instances, the output fonts can include reasonable results.

However, there is a need for extensive research using highly stylized display fonts. The results for traditional text fonts may be passable, but these fonts are not as precise and exacting as a developer requires them to be. Accordingly, these passable fonts sit in an “Uncanny Valley” where the glyphs are recognizable but include minor issues and inconsistencies that can be alerting to the developer. Accordingly, the server 102 can retrieve and obtain hard, hyper-specific data about every individual glyph within a font and use the font genome data for downstream tasks. These tasks include, for example, conditioning the machine learning models during training and creating a new font from a target font for a particular glyph.

In some implementations, the server 102 can utilize the font genome data to condition the generative machine learning model to produce more exacting results for text fonts. The more exacting results can result in more uniformity to fonts, fonts that lack inaccuracies, and fonts that are generally easier to read. In particular, the server 102 can encode hyper-specific details to condition or train the generative machine learning models to produce fonts that match to developer specification.

In some implementations, the server 102 can apply the font genome data to various applications. Whether through a more traditional search using a query builder, for example, or through a chat interface on top of a backend query builder, the server 102 can expose the font genome data to aid font designers in identifying new fonts and identifying old fonts. In this manner, typographers will have access to a large and rich database full of various fonts.

In some implementations, the server 102 can condition or train the generative machine learning model with various improvements. As further described below, the output of the generative machine learning model will be more-finetuned to match developer specifications. Some font genome data may be more useful for conditioning the generative machine learning models and some font genome data may be more applicable to the application of the generative machine learning model, such as retail search. In particular, data that has more understandable human meaning can be applied directly to retail search, e.g., to customize search engine results, and more abstract results or measures can be used to condition the generative machine learning model. For example, a developer may care about a particular proportion of a glyph, e.g., its height to width ratio, but that proportion may be calculated as an average by a generative machine learning model that was not trained using font data. Here, by conditioning the generative machine learning model using a large set of font genome data, the server 102 can provide the developer the ability to specify the particular proportion of the glyph, feed that particular proportion into the generative machine learning model, and produce, from the generative machine learning model, a set of character glyphs that meet the criteria of the particular proportion. In this case, the develop can specify a desired 2:1 heigh to width ratio as the particular proportion.

In some implementations, the font genome data utilized to condition the generative machine learning model may be more abstract. In particular, artificial intelligence centric data or data used to condition the generative machine learning model may include measures that developers have a more difficult time making sense of their meaning. However, the generative machine learning model can leverage the artificial intelligence centric data to identify nuances otherwise not seen by users, and can leverage this technical advantage to improve generated results.

For example, on a glyph-by-glyph basis, the generative machine learning model can be trained using different characteristics of glyphs. These characteristics include, for example, width, height, heightRatio, centroidX, centroidY, totalContours, totalIslands, totalLakes, totalSegments, totalLines, totalCurves, length, lineLength, curveLength, longestLines, longestCurve, and area. An island refers to a contour that puts ink on the screen, e.g., a counterclockwise contour as drawn by a font renderer. A lake is a contour that does not display ink, e.g., a clockwise contour that a font renderer can use to remove ink. Islands/lakes seemed like easier terminology to use and they represent the texture of the font. For example, a standard W can be continuous, e.g., one island, but a W with multiple islands can include an ornate W.

In some cases, on the glyph-by-glyph basis, the generative machine learning model can be trained using the different characteristics for each of the three largest islands and lakes. The generative machine learning model can capture the base font metrics that includes, for example, ascenderHeight, descenderHeight, capHeight, xHeight, and horizontalAdvance, which can sometimes be autocalculated and stored in a font file, such as in the font genome data. The base font metrics can sometimes be incorrectly entered for a font, though, and can therefore be reliant on a human to complete.

In some cases, a benefit of conditioning the generative machine learning model using the font genome data is that patterns found can improve the ability for the model to find patterns. For example, if the font genome data includes glyphs where the totalSegments characteristics is higher than normal, and the longestCurve is smaller than normal, than the generative machine learning model can detect for that glyph that a texture or treatment has been applied to it.

As illustrated in FIG. 1, the server 102 can generate different glyphs for a designated font. The server 102 can generate, using the generative machine learning model, a first set of glyphs that recite “text font”. However, the first set of glyphs may be in the uncanny valley. The server 102 can generate, using the generative machine learning model, a second set of glyphs that recite “magic middle”. However, if the generative machine learning model is not conditioned or not trained appropriately using font data, its output may be difficult to read and not uniform. For example, as illustrated in FIG. 1, a generative machine learning model that was not trained using font data can produce a third set of glyphs that recite “Display Font” and is obscured.

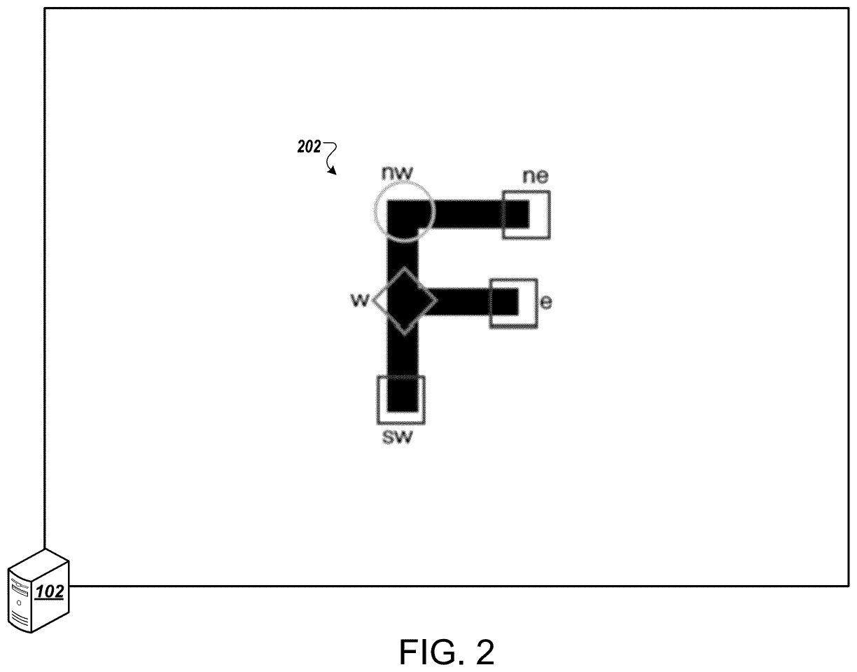

FIG. 2 is a block diagram illustrating examples of different strokes 102 utilize to create a character. The different strokes 102 can include different keypoints. In some implementations, the server 102 can analyze various keypoints when denoting variation in each letter. For instance, there are at least six types of keypoints. Although keypoints is not a typeface industry term, a keypoint aids in defining a glyph. For instance, a keypoint is currently defined using cardinal directions to aid the generative machine learning model to find such keypoints on contours of a glyph.

For example, the various keypoint types can include terminal, join, meet, waypoint, cross, and tittle. A terminal includes where one stroke ends in a peninsula. A join includes where the ends of two strokes come together. A meet includes where the end of one stroke ends in the middle of another stroke. A waypoint includes a middle potion of a continuous stroke that is likely to be easy to find. A cross includes where two strokes meet while continuing on their way. A tittle is a small marking, only found on glyphs “i” and “j.”

The server 102 can collect and store keypoint data. The server 102 can apply a bounding box for each keypoint of a glyph, as defined by x, y, width, and height. Although this information may not be generally relevant to a human, the keypoint data provides helpful guidance for the generative machine learning model. A set of tags, e.g., serif type, is applied for each keypoint. In some cases, the server 102 may automatically apply the set of tags for each keypoint. In some cases, a developer may manually tag each keypoint for the set of tags. For example, the server 102 can clip each training image of a glyph to the bounding box. The server 102 can provide as input to an image classification model each clipped training image to determine serif type and other related modalities.

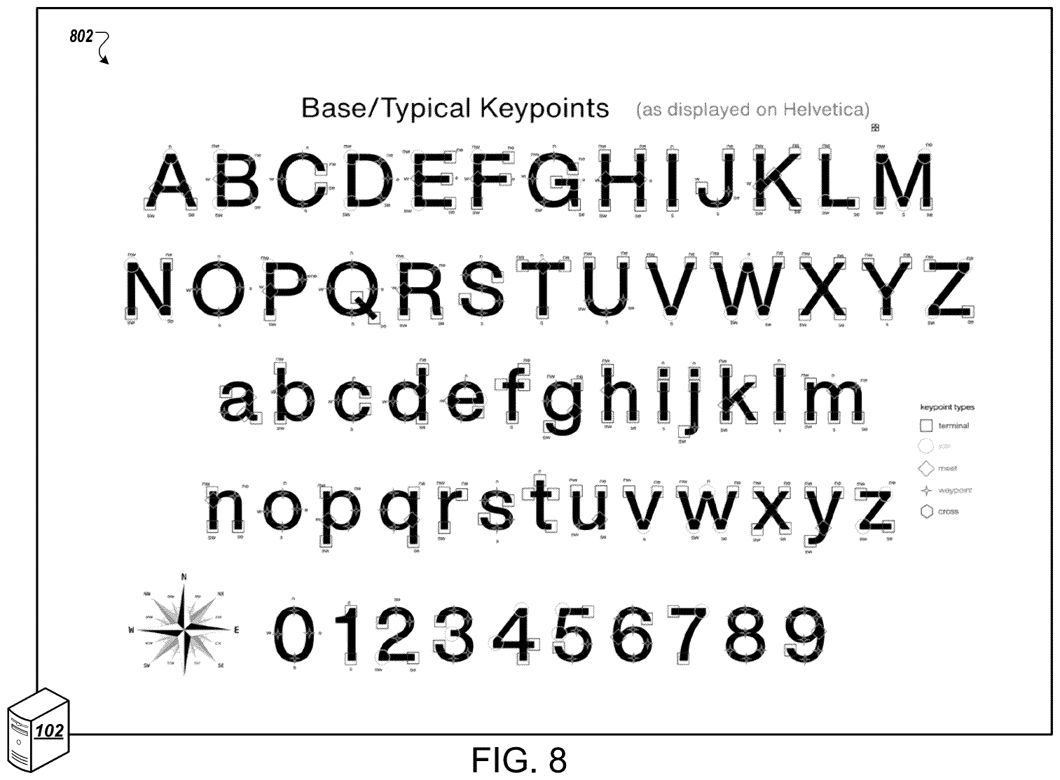

In some cases, each stroke of a glyph is defined by the order of keypoints it travels through. For example, a base or typical keypoint for all Latin letters are found in FIG. 8. For example, the letter F has three strokes. Stroke 1 is from northwest (NW) to southwest (SW). Stroke 2 is from NW to northeast (NE). And stroke 3 is from West (W) to East (E).

The server 102 can collect various data on these glyphs. For example, the server 102 can analyze each of the contours between and including keypoints for each of the glyphs shown in FIG. 8. The server 102 can determine through calculation three statistics for both angle and width. These three statistics include an average, a standard deviation, and a mode. If the server 102 determines that the standard deviation is low, that informs the generative machine learning model that the stroke does not vary much. However, if the server 102 determines that the standard deviation is high, this tells the model that the stroke varies often. The mode informs the model what the most common width and angle are for the stroke.

In some implementations, the server 102 can collect abstraction information from each of the glyphs. The abstraction information is relatable to a developer or designer of fonts. For example, many abstractions are placed on top of data to make the data more human relatable to query.

In some examples, the openness of a glyph “C” could be defined by the vertical distance between two terminals, or has a higher ink-ratio (or “average gray value”) on a closed “C” than an open “C.”

In some examples, the server 102 can create a proxy measure for contrast to analyze each of the weight and width of horizontal strokes against vertical strokes and both diagonals.

In some cases, font developers may likely use the average values for the width and angle of the stroke, with some abstraction on top of the standard deviation. For example, the abstraction on the top of the standard deviation may reflect instructing to tell the search “I want the first stroke to be ‘curvy’ or ‘straight’”. The server 102 can provide controllable access to the user for the abstraction. For example, the server 102 can expose the abstraction to a user through a graphical user interface. The abstraction can include a text box, a slider, a search engine, e.g., which executes on SQL on the backend, or through a large language model (LLM) that prompts the user for queries and provides answers.

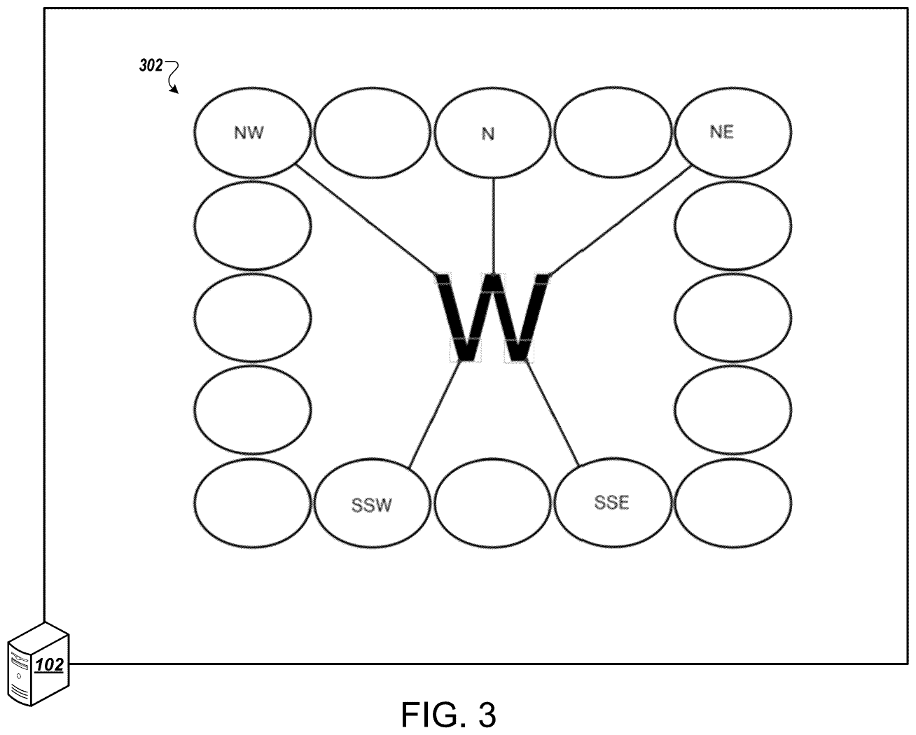

FIG. 3 is a block diagram illustrating an example of measuring characteristics of a glyph. As shown in FIG. 3, the server 102 can utilize a data collection methodology 302 for analyzing each glyph. Generally, there have been an innumerable number of experiments performed to determine what works for analyzing glyphs. However, problems exist for analyzing glyphs because certain glyphs can take on whatever creative liberties exist. For instance, the server 102 can perform an algorithmic approach, as shown in FIG. 3.

For each glyph, the server 102 retrieves a value for a LetterForm. The LetterForm contains what keypoints exist for that variation. The keypoints here include, for example, KeypointType and Direction. The server 102 can determines the logical strokes between each keypoint. Using this information, the server 102 can measure data about strokes in each character glyph of a font.

As illustrated in FIG. 3, one such method for analyzing the glyph includes the server 102 constructing one oval per cardinal direction at a “sufficiently far distance” from the glyph. The server 102 retrieves the cardinal directions as defined for the LetterForm. Then, using the cardinal directions, the server 102 finds the closest point on any of the glyph's contours to the oval. Using the closet point, the server 102 traverses along that contour starting at that identified point until various criteria are met. The various criteria include, for example, widths, angles, and rates of changes, as the server 102 traverses the glyph to determine a bounding box.

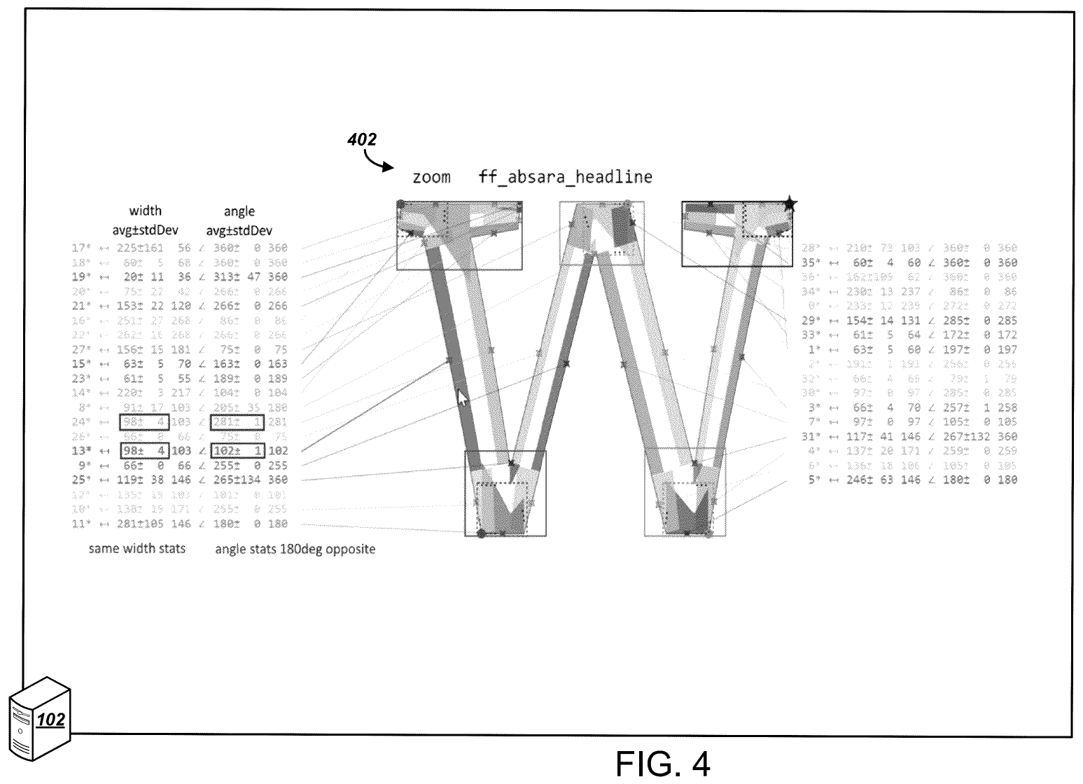

FIG. 4 is a block diagrams illustrating examples of measuring characteristics of a glyph. As shown in FIG. 4, the server 102 can utilize a strokes methodology 402 for analyzing each glyph. In the strokes methodology 402, the server 102 traverses along each contour of a glyph at one unit increments. The server 102 measures the angle of the contour at each point and measure a closest width perpendicular to that location. After measuring the angle of the contour and the closest width perpendicular to that location, the server 102 groups those locations into logical groups based on changes in angle, changes in width, and which contour that location's width measures against.

Using these grouped characteristics, the server 102 analyzes spaces between the keypoints that include each stroke and summarizes the widths and angles. In some cases, the server 102 draws keypoints as experimental keypoints. As illustrated in FIG. 4, the NW-SW stroke has a width of the following parameters: average=93, standard deviation=4, and mode=103. Additionally, the angle at point shown in FIG. 4 is reconciled between two opposing sides and would be average 102, standard deviation=1, and mode 102.

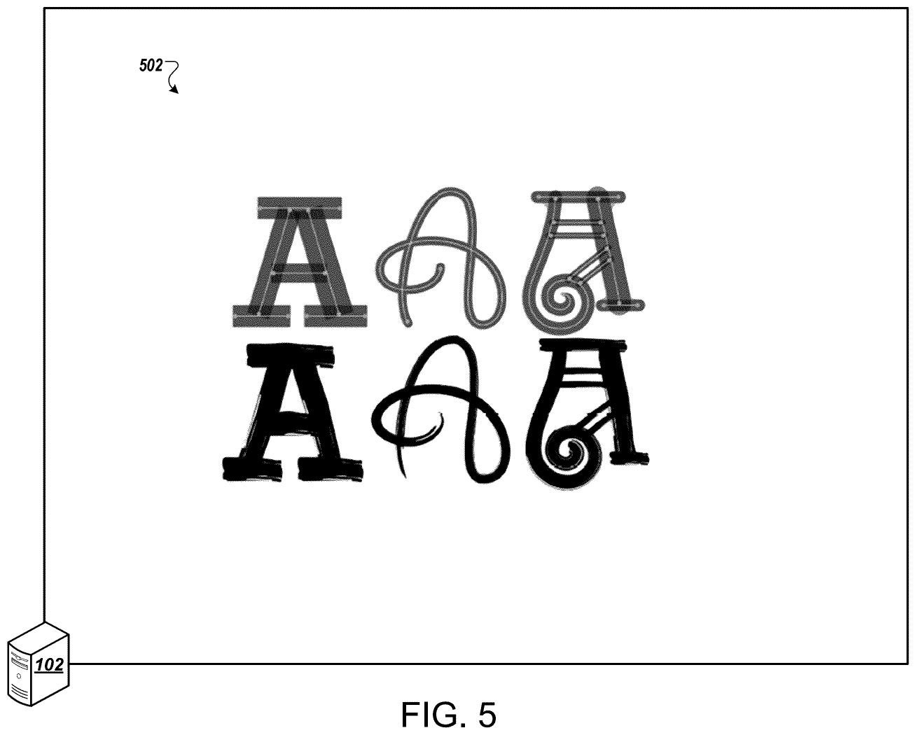

FIG. 5 is a block diagram that illustrates an example of fonts analyzed using automatic keypoint detection. As illustrated in FIG. 5, the server 102 can execute an automatic keypoint detection 502 to analyze each of the glyphs. For some letters, the algorithmic approach cannot be relied upon to detect internal features cardinal directions. In particular, the error rate for more ornate fonts, e.g., calligraphic fonts, can be high, e.g., about 15%, when applying the algorithmic approach. The automatic keypoint detection 502 relates to using image correspondence to capture cardinal keypoints. This approach can be used to enable more precise control over where keypoints are detected.

In some implementations, the automatic keypoint detection 502 can utilize image correspondence based keypoint detection. While cardinal direction based keypoint detection works relatively well for the server 102, the server 102 may perform this process against miscellaneous edge cases with more stylistic fonts, such as flags or flourishes on terminals. The automatic keypoint detection 502 may not work as well on, for example, Chinese, Japanese, and Korean glyphs as there are far more internal features. In these edge cases, it is beneficial to map logical strokes or keystrokes to the physical strokes that the server 102 detects.

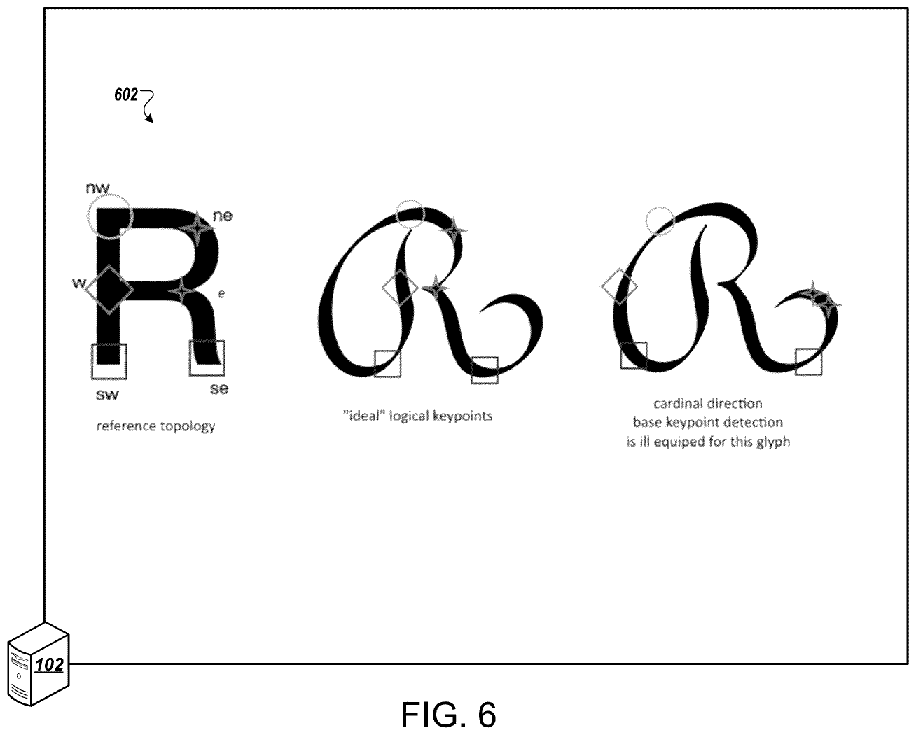

FIG. 6 is another block diagram that illustrates an example of fonts analyzed using automatic keypoint detection. In particular, FIG. 6 illustrates different keypoint references 602 overlaid on different glyphs. To create the font genome data, the server 102 needs to identify a set of pre-defined strokes that a human can naturally realize as certain characteristics of a glyph. For example, the server 102 should identify “the left leg of an A”, “the crossbar of the A”, and etc., even if there are flourishes or two logical strokes are merged into a continuous physical stroke. The server 102 can utilize a reference topology for a letter “R” to identify a set of predefined stroke for the letter R in other fonts, as illustrated in FIG. 6. Based on the reference topology for the letter “R,” the “ideal” logical keypoints that the server 102 can detect is illustrated as the middle “R” shown in FIG. 6. However, if the server 102 utilizes the cardinal direction base keypoint detection, then the far right “R” shown in FIG. 6 illustrates the detected keypoints, which do not match to the reference topology in the far left “R” and the ideal logical keypoints in the middle “R”.

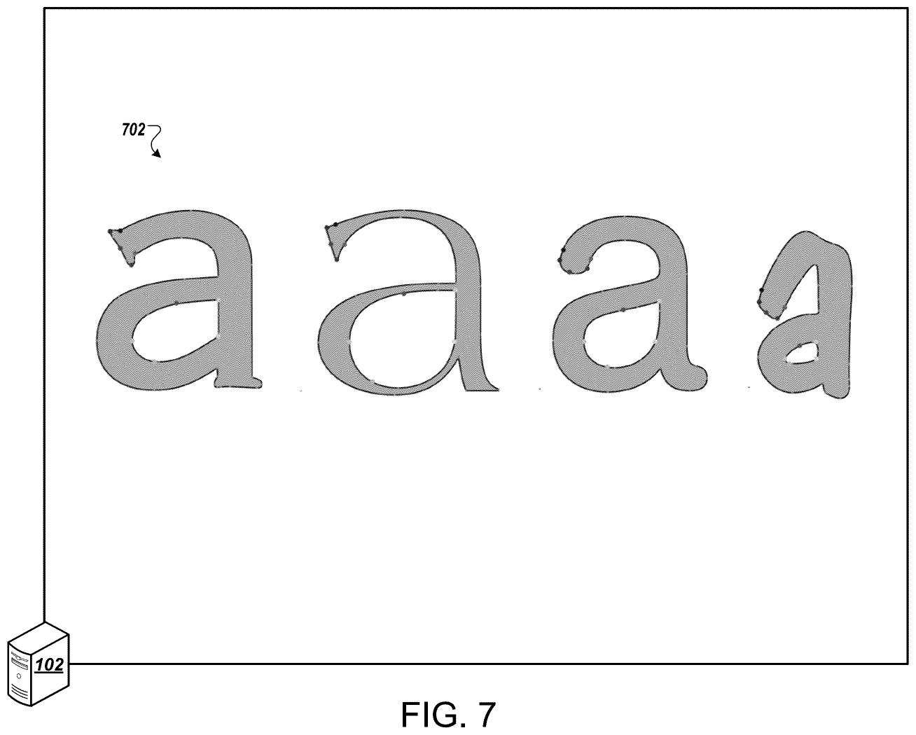

FIG. 7 is another block diagram that illustrates an example of fonts analyzed using automatic keypoint detection. In order to remedy the issue identified in FIG. 6, the server 102 can rely on a classification of computer vision problems called Image Correspondence. In particular, the server 102 can utilize Image Correspondence 702 to identify certain features of glyphs. The Image Correspondence 702 is relied on to determine a three-dimensional location of a camera from a video feed. Specifically, the Image Correspondence 702 can be implemented using Simultaneous Localization and Mapping (SLAM), and can repurpose this functionality for keypoint identification. By utilizing Image Correspondence for analyzing glyphs, the server 102 can return granular and accurate keypoints identified for glyphs. For example, the server 102 returns not just a location of the top-left terminal of the capital letter “W”, but also locally interesting points on the terminal. These points are shown in FIG. 7, such as 701 and 703.

FIG. 8 is another block diagram that illustrates an example of fonts analyzed using automatic keypoint detection. For example, FIG. 8 illustrates a set of glyphs in Helvetica including upper case letters, lower case letters, and different number 0 through 9.

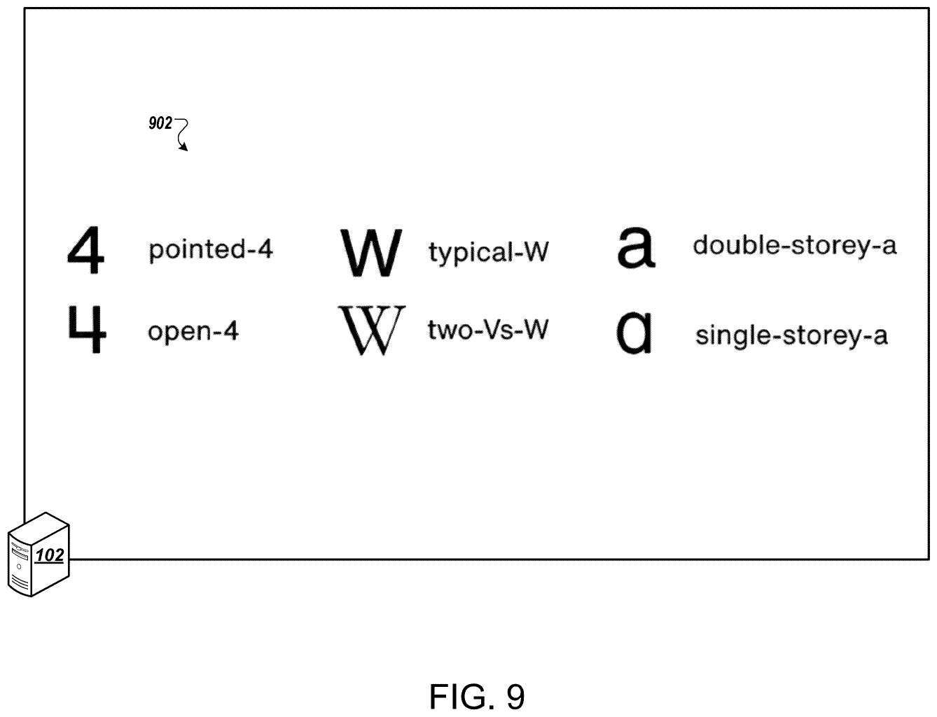

FIG. 9 is a block diagram that illustrates an example of fonts analyzed using automatic keypoint detection. For example, FIG. 9 illustrates different descriptions for glyph variations. The glyph “4” is described as a pointed-4 or a different “4” is described as an open-4, the glyph “W” can be described as a typical-W or a two-Vs-W, and the glyph “a” can be described as a double-storey-a or a single-storey-a.

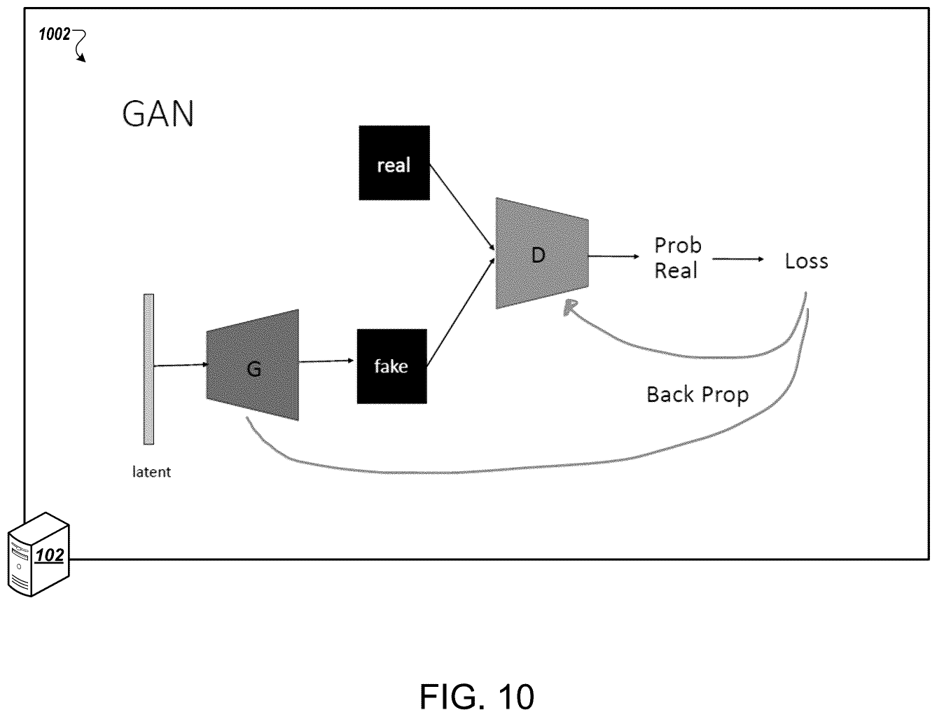

FIG. 10 is a block diagram illustrating an example of a generative adversarial network. A generative artificial intelligence model or genAI model is a type of artificial intelligence that uses generative models to produce text, images, videos, or other forms of data. The genAI models can learn underlying patterns and structures from their training data and use those learned inferences to produce new data based on the input. For example, the genAI can remove the “toil” of completing a typeface and be utilized with a language extension. In some cases, the genAI can correspond to a multimodal typeface creation. In some cases, the genAI can be utilized for font art or font creation. The genAI model can be trained using a backwards propagation, which iteratively seeks to adjust weights and bias of the genAI model to minimize any cost function associated with the model.

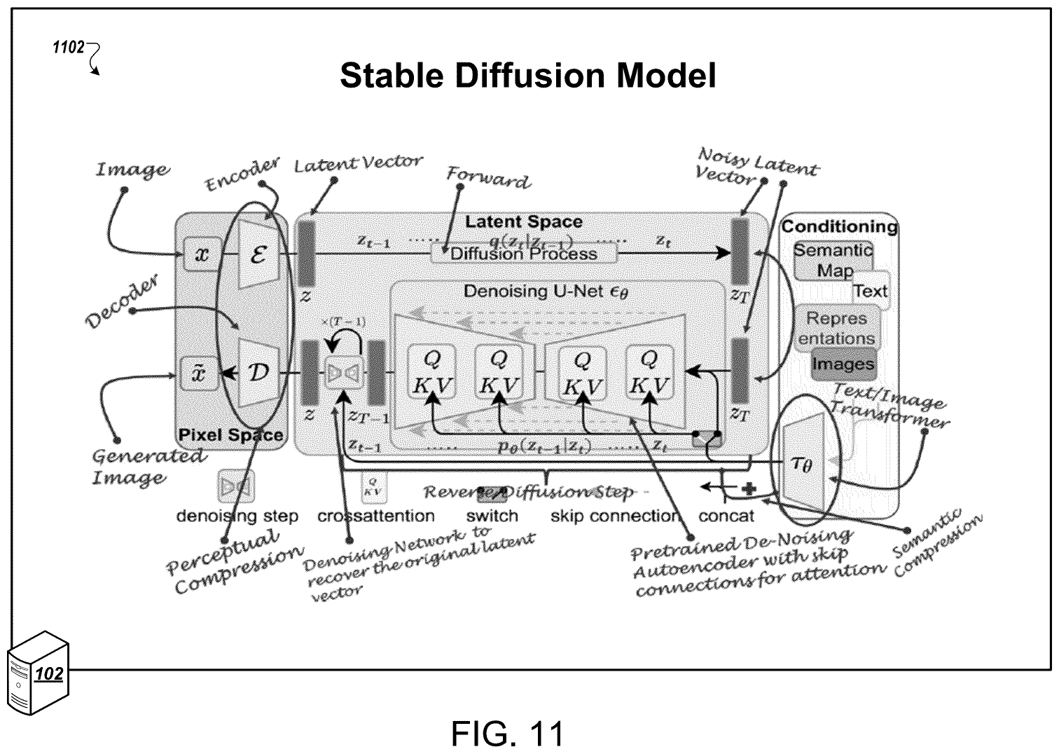

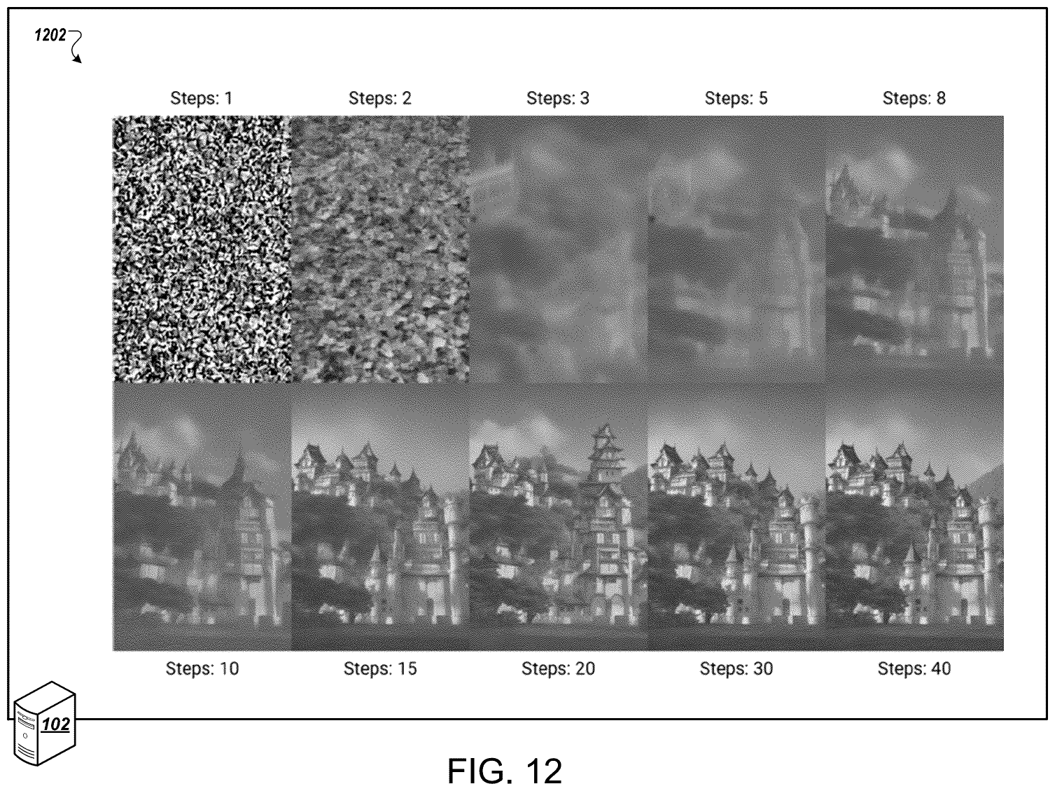

FIG. 11 is a block diagram illustrating an example of a stable diffusion model. In FIG. 11, the genAI model can include a stable diffusion model. A stable diffusion model is a generative artificial intelligence model that can produce unique photorealistic images from text and image prompts. In particular, a stable diffusion model operates by using gaussian noise, for example, to encode an image. Afterwards, the stable diffusion model can use a noise predictor together with a reverse diffusion process to create the image. For example, the output of the stable diffusion model can be an N×N resolution image, e.g., a 512×512 resolution image. The various components of a stable diffusion model include, for example, a variational encoder, a denoising network, a noise schedule, and text conditioning guidance mechanism. The stable diffusion model can perform, for example, text to image generation, image to image generation, creation of graphics or font art, image editing, and video editing, to name a few examples. FIG. 12 is one such example of the outputs of a stable diffusion model at different steps, e.g., step 1, step 2, and through to step 40. As the stable diffusion model iterates and processes an input noisy image at step 1, the image becomes clearer through to step 40.

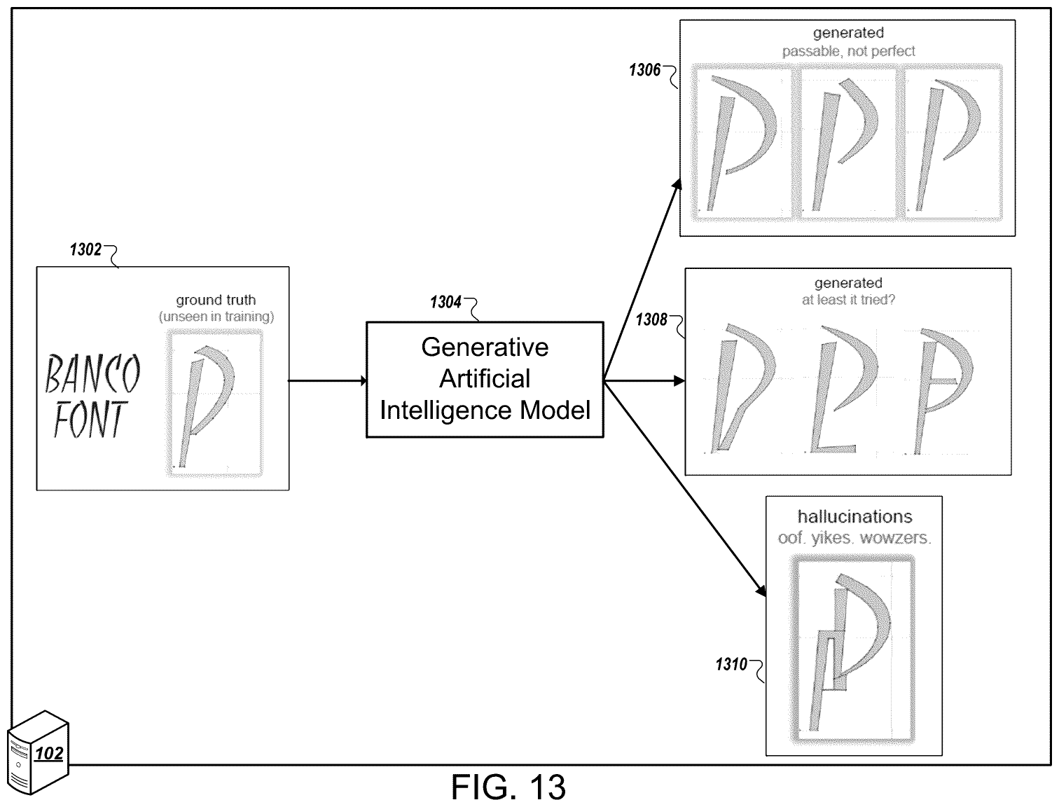

FIG. 13 is a block diagram illustrating an example of a generative artificial intelligence model 1304 creating different font outputs from a ground truth font. The generative artificial intelligence model 1304 can receive a ground truth image 1302 and produce different outputs, e.g., a generated output 1306, another generated output 1308, and a generated output 1310 with hallucinations.

In some implementations, a goal of the server 102 is to leverage the power of generative artificial intelligence to significantly empower font designers and creative professionals by making their work more efficient and streamlined. The generative artificial intelligence model 1304 can be trained, for example, with 16k training images and in response, produce over 150k images.

In some cases, the generative artificial intelligence model can be trained using scalar conditional control. The scalar conditional control is a mechanism in which a numerical parameter is used to condition or control certain aspects of the model's behavior. In some cases, the generative artificial intelligence model can be trained using embeddings. In some cases, the stable diffusion model of the generative artificial intelligence model can be conditioned on a depth estimation.

In some implementations, the generative artificial intelligence model 1304 can receive input characters. For example, the characters for “Adhesion” or “HamburgerFONT” as a solid blueprint for the rest of the characters in the font. Based on these input characters, the generative artificial intelligence model 1304 can identify emerging patterns, and the same set of data is fed into an inference pipelines. Moreover, the generative artificial intelligence model 1304 can generate embeddings that are glyph agnostic.

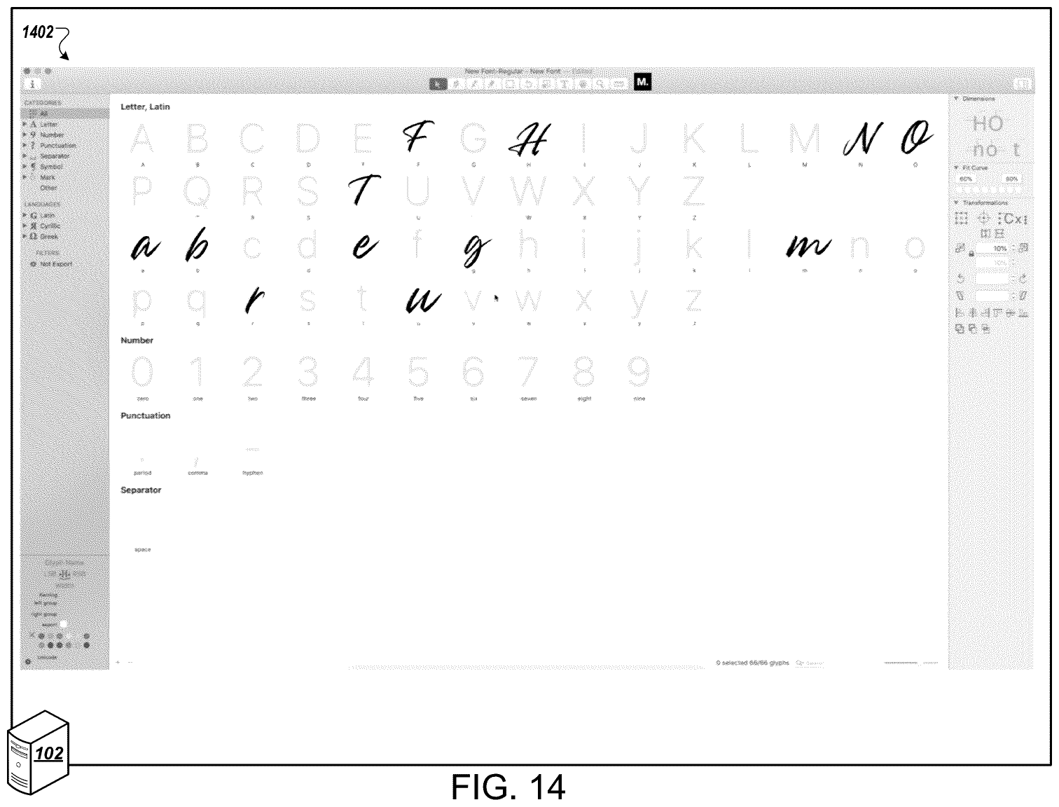

FIG. 14 is a block diagram illustrating a creation of different glyphs for a desired font. In FIG. 14, the user interface 1402 illustrates different glyphs generated by the generative artificial intelligence model for a designated font. As illustrated in user interface 1402, the generative artificial intelligence model can generate letters, numbers, punctuations, and different separators.

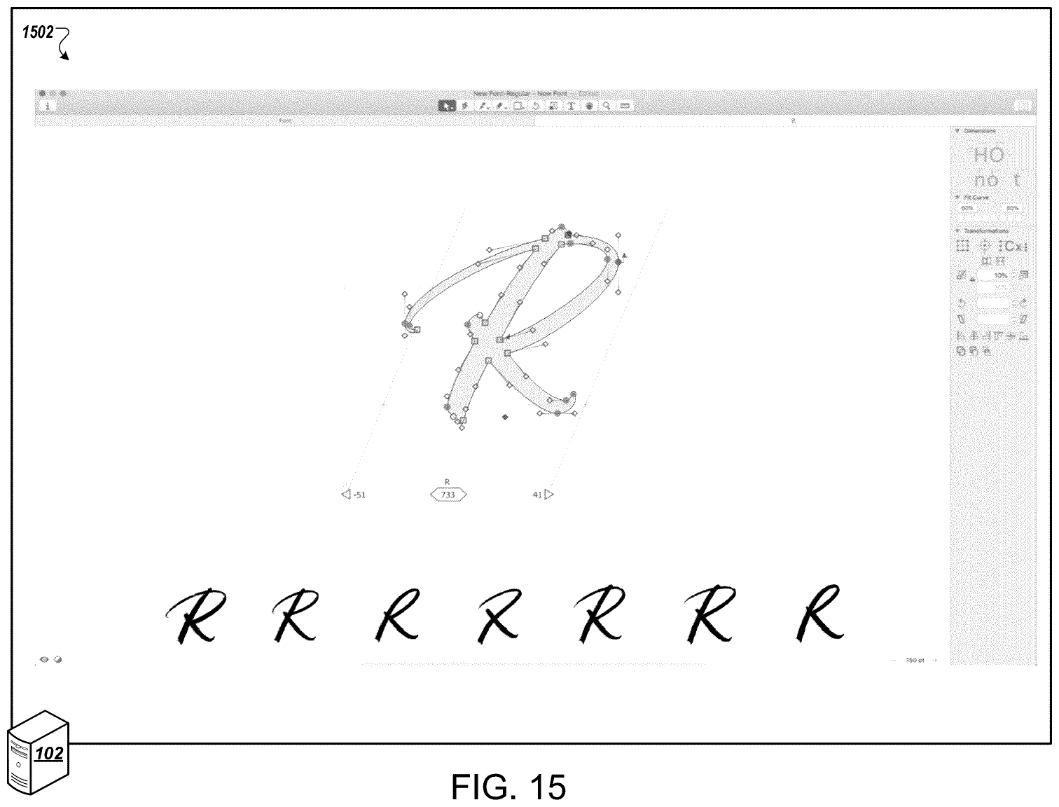

FIG. 15 is a diagram illustrating a glyph in a desired font. Specifically, FIG. 15 illustrates a user interface 1502 displaying one or more keypoints detected on the letter “R” using image correspondence performed by server 102. Moreover, the user interface 1502 displays different iterations of the letter “R” produced by the generative artificial intelligence model.

In some implementations, the server 102 utilizes the generative artificial intelligence model to empower font designers and creative professionals by making their work more efficient and streamlined. The server 102 can gather various metrics for the font genome data to train the generative artificial intelligence model. Example metrics for the letter “W” include base glyph metrics and “W” specific metrics. The base glyph metrics include centroid X, centroid Y, contours, counters, segments, straight perimeter, curved perimeter, perimeter, area, width, and height. The “W” specific metrics include terminal style (NW, SW, N, SE, NW), center style (join at cap height, join at x height, symmetric join, asymmetric join, double V), stroke angle (average, standard deviation, mode), stroke thickness (average standard deviation, mode), serif metrics (height, width, symmetry, bracket size), swash curvature and length, and centerline skeleton.

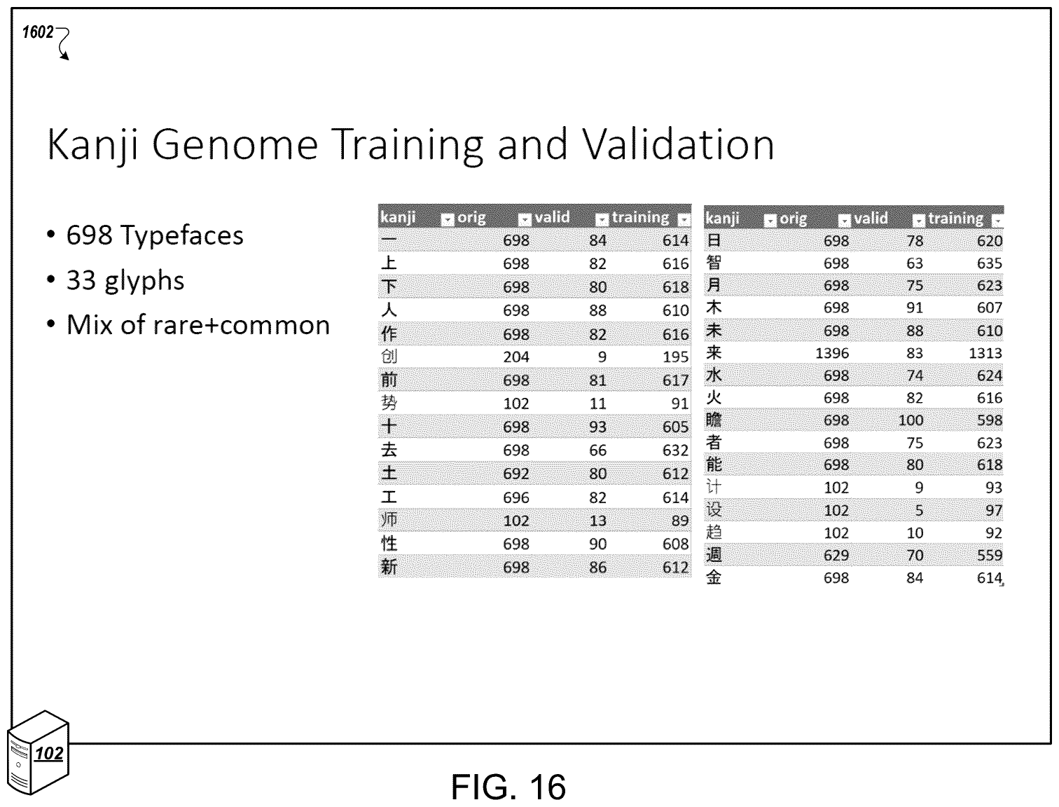

FIG. 16 is a diagram illustrating training data for a genome. In particular, FIG. 16 illustrates training data 1602 for kanji genome training and validation. The training data 1602 includes, for example, 698 typefaces, 33 glyphs, and a mix of rare and common information.

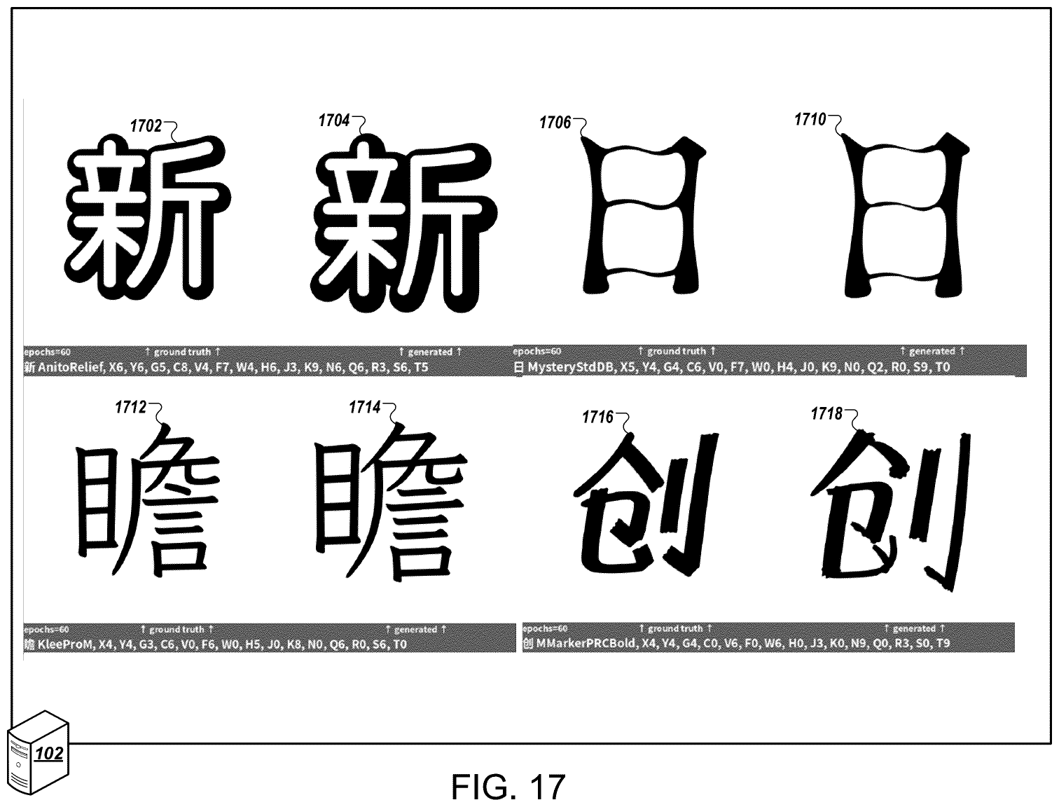

FIG. 17 is a diagram illustrating example ground truths and corresponding generated glyphs created from the generative artificial intelligence model. In FIG. 17, the generative artificial intelligence model can generate glyphs 1704, 1710, 1714, and 1718. The model can generate these glyphs based on ground truth glyphs 1702, 1706, 1712, and 1716. For example, the generative artificial intelligence model generates glyph 1704 based on ground truth 1702, glyph 1710 based on ground truth glyph 1706, generates glyph 1716 based on ground truth 1712, and glyph 1718 based on ground truth glyph 1716.

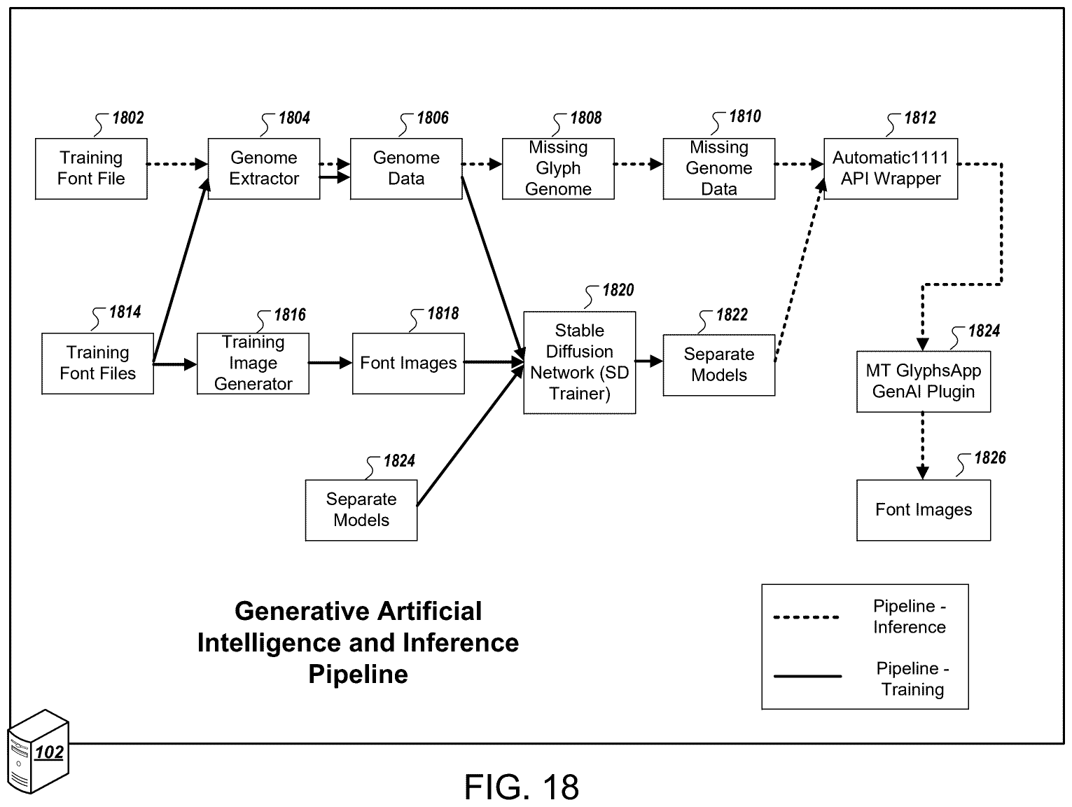

FIG. 18 is a block diagram that illustrates a generative artificial intelligence training and inference pipeline. The server 102 includes the various processes for the training and inference pipeline.

In some implementations, the processes shown in FIG. 18 include an inference pipeline, represented by the dotted lines, and a training pipeline, represented by the boldened line.

In the training pipeline, the training font file 1802 can include font data utilized in a glyph application. The training font file 1802 is provided as input to a genome extractor 1804. The genome extractor 1804 receives the training font file 1802 and data from training font files 1814. In response, the genome extractor 1804 extracts genome data 1806 from the training font file 1802 and the data from training font files 1814. The genome data 1806 can include, for example, 100 metrics per glyph, such as stroke angles, thickness, centroid, perimeter, area, and tags. The genome data 1804 is provided to a missing glyph processor 1808 that seeks to identify missing glyphs from the genome data 1806. The output of the missing glyph processor 1808 is missing genome data 1810, which is subsequently passed to an automatic1111 API wrapper 1812. Other API wrappers may be used than automatic1111 API wrapper 1812. The API wrapper 1812 can receive the missing genome data and data from separate models 1822 that were trained to process different font types. The output of the API wrapper 1812, the missing genome data, is provided to the MT GlyphsApp GenAI Plugin 1824, and subsequently the Plugin 1824 outputs font images 1826 for the developer to review.

In the inference pipeline, the training font files 1814 are provided as input to the genome extractor 1804 and the training image generator 1816. The training image generator 1816 processes the training font files 184 to create font images 1818. The stable diffusion network 1820 receives the font images 1818 and data from the separate models 1824. The output of the stable diffusion model 1820 is provided as input to the separate models 1822 to be trained on different font types.

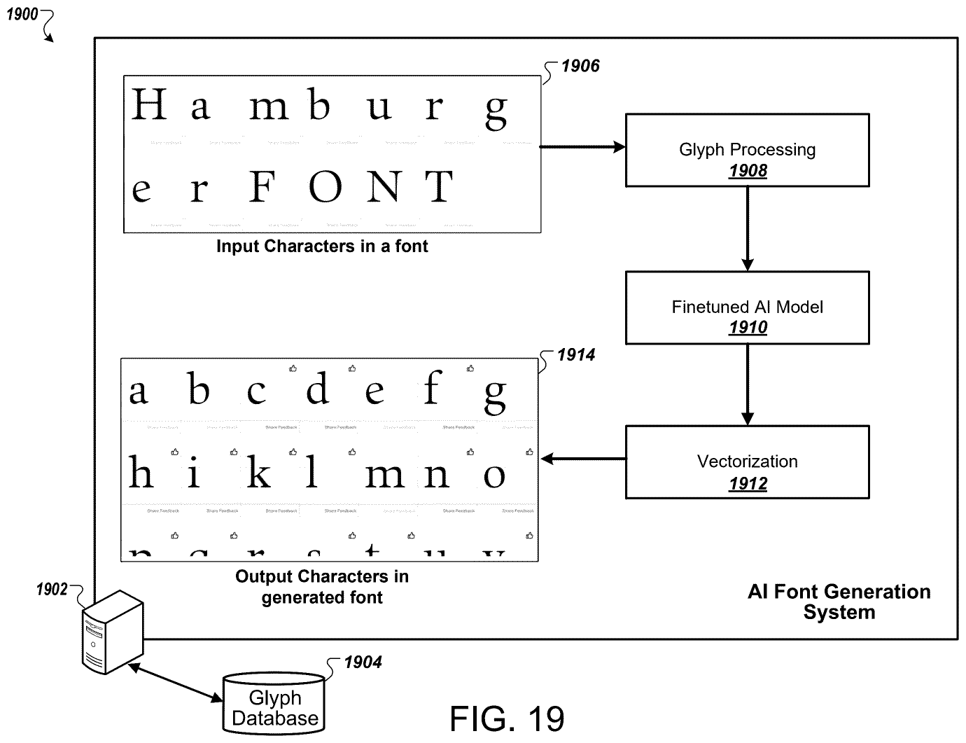

In some implementations, the font images 1826 generated from the inference and training pipelines can be utilized to generate new fonts using few-shot learning as further described below. The server 102 can store the font images 1826 in a database, such as a glyph database. The processes performed in FIGS. 19-21 can utilize the font images 1826 stored in the glyph database for further processing.

FIG. 19 is a block diagram that illustrates an example of a system 1900 for generating new fonts using few-shot learning. In some implementations, the system 1900 comprises an artificial intelligence (AI) font generation system 1902 and a glyph database 1904. The AI font generation system 1902 and the glyph database 1904 can communicate over a network, such as the Internet. One or more user devices, e.g., client devices, can connect to and interact with the components of the AI font generation system 1902. In some cases, the AI font generation system 1902 is similar to the server 102.

Typography can play an essential role in modern communication, branding, and design. Traditional font creation is a time-consuming process that can require expert knowledge and meticulous attention to detail. This can often take weeks, months, or longer for a designer to develop a fully realized typeface. Over the years, digital tools have simplified some aspects of typography—designers can more easily manipulate outlines, modify spacing, and iterate on shapes than ever before. Yet, creating novel fonts that maintain visual consistency and character cohesion across an entire typeface remains a significant challenge.

In some cases, the system 1900 can automatically generate fonts by using machine learning models that have been trained on large datasets of existing typefaces. For instance, generative adversarial networks (GANs) and other deep learning techniques have demonstrated their ability to produce glyphs resembling those found in high-quality, professionally designed fonts. However, these methods may rely on extensive training data, which can be difficult and costly to assemble. Moreover, they may generate results that lack the unique aesthetic flair envisioned by a human designer.

The industry is increasingly interested in “few-shot learning” techniques that can produce new and coherent typefaces from only a small sample of characters. By supplying a limited set of glyphs-such as a handful of letters-designers can guide the system to extrapolate stylistic features and apply them consistently across the entire alphabet. This approach not only precludes the need for extensive up-front design but also makes the process more efficient and collaborative, allowing the designer's creativity to guide the machine learning model.

The system 1900 leverages few-shot learning to combine the strengths of human-led design with the efficiency of automated generation. By requiring only a small set of glyphs as input from a designer, the proposed system can quickly create a full range of glyphs while preserving the designer's intended aesthetic. Accordingly, the system 1900 aims to fill a growing industry need for rapid, scalable, and customized font creation pipelines.

In some implementations, the system 1900 can enable rapid and customized font creation by leveraging one or more few-shot learning mechanisms. For example, the system 1900 can start with a designer providing a small set of hand-drawn characters, reflecting their desired font aesthetic. Using a form of the small set of hand-drawn characters, a fine-tuning artificial intelligence model can extrapolate from these initial characters to generate additional glyph images in a similar style, e.g., to generate remaining glyphs of the font in the desired user style. In response, the system 1900 can transform the AI-generated additional glyph images into vector outlines, for example. The vector outlines can align seamlessly with the designer's original look and feel-including consistent scale and alignment.

In some cases, a designer can supply any number of initial characters. In some cases, the system 1900 can retrieve any number of initial characters from the glyph database 1904. In this manner, the system 1900 allows for both a minimum number of inputs and a more comprehensive direction based on specific project needs.

In some implementations, the AI font generation system 1902 can create a font by leveraging one or more few shot learning mechanisms. These mechanisms can include, for example, functions associated with glyph processing 1908, functions associated with a finetune AI model 1910, and functions associated with vectorization 1912. As mentioned, the AI font generation system 102 can receive one or more input characters of a particular font type, and use these mechanisms to generate output characters in the desired font from the input type.

In some examples, the input characters 1906 in a particular font may include the glyphs for “hamburgerFONT” or another font as an example of a font that is similar to the user's desired aesthetic. The input characters 1906 here include a set of number of lower-case letters and a set number of upper-case letters. In some examples, the one or more input characters 1906 can be retrieved from the glyph database 1904. In some examples, the input characters 1906 can be received from a user through a client device or a user directly interacting with the AI font generation system 1902.

In some implementations, the glyph database 1904 can store the glyphs and characterization data for a set of character glyphs in the font. The characterization data can include stroke attributes. The stroke attributes can represent a numerical control method to render each stroke of the character glyph. The AI font generation system 1902 can utilize the characterization data to inform available font options for font generation. The AI font generation system 1902 can retrieve the glyphs from the font genome stored in the glyph database 1904 for producing an output character set representative of a font.

Generally, the AI font generation system 1902 can process the input character or characters 1906 using the finetuned AI model 1910. The finetuned AI model 1910 can produce a total set of output characters 1914 in the particular font, e.g., such as lowercase letters “a” through “z” and upper-case letters “A” through “Z”. The finetuned AI model 1910 can analyze various characteristics of the input characters 1906, e.g., the style, the kerning, the right/left side bearing around the strokes of each character, and other characteristics, to gain an understanding of the desired font to be applied to output characters 1914. In some implementations, the AI font generation system 1902 can produce output characters 1914 in the generated font. The output characters 1914 can include each character of the alphabet in lower case and upper-case, numbers 0 through 9, and various symbols, to name a few examples. The AI font generation system 1902 can present the output characters 1914 in the generated font through a glyph application, e.g., one or more user interfaces for font generation and selection, presented to a user on a display of a connected user device.

In some implementations, the finetuned AI model 1910 can output a representation of the output characters. The representation may include, for example, raster images for each output character or other data types representative of the output characters.

Before the output characters are presented to the user, e.g., for selection, the AI font generation system 1902 can provide the representation of the output characters through one or more functions associated with vectorization 1912. As an example, the vectorization 1912 can refit the represented output characters back to a format to be presented in a glyph application. As will be further described below, the vectorization 1912 can include reformatting the output characters with proper spacing between characters, proper orientation, correct scaling, and similar format, to name a few examples.

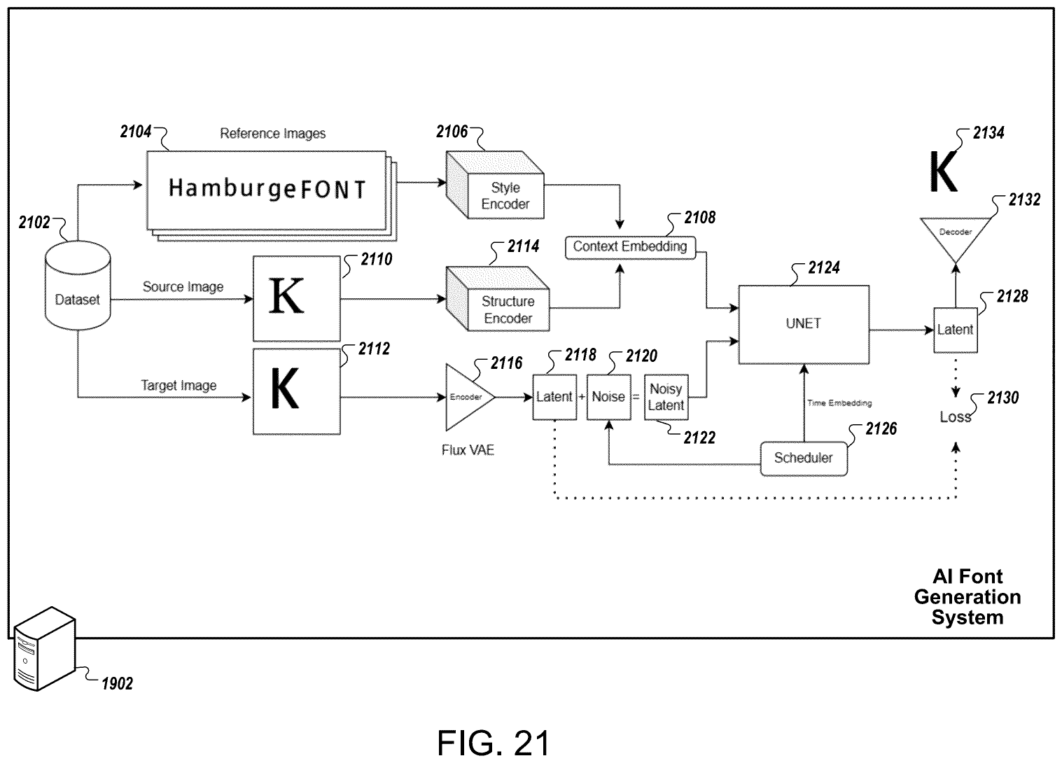

In some cases, the AI font generation system 1902 can receive feedback on each of the generated output characters 1914. The feedback can include an indication of whether the character data is properly produced by the finetuned AI model 1910. In this context, the system can verify that the aesthetic consistency of the fonts and verify whether any spurious artifacts were generated, e.g., a line that is too long on an “q” glyph. The user can indicate that a particular character is acceptable or needs fixing, e.g., through a graphical user interface (GUI) presented through the display of the user device. If the AI font generation system 1902 provides feedback for a particular character or multiple characters that need fixing, then the AI font generation system 1902 can attempt to reprocess that particular character using the desired font, such as using the process shown in FIG. 21 below.

In some implementations, the output characters 1914 in the generated font may be stored in the glyph database 1904. In some cases, the output characters 1914 may be further redefined using one or more other machine learning models. In some cases, these output characters 1914 may be applied to one or more applications for use and deployment.

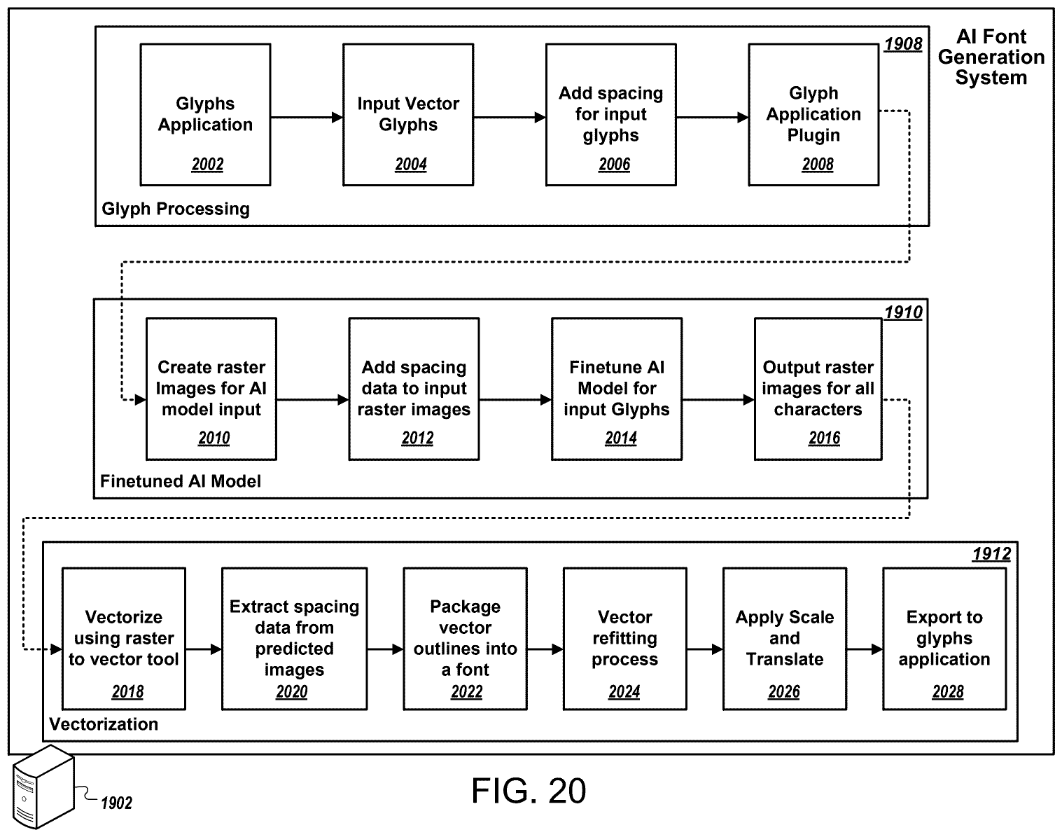

FIG. 20 is a block diagram that illustrates an example of a system that utilizes artificial intelligence techniques to generate new fonts based on one or more input characters. The system shown in FIG. 20 illustrates the processes performed by the AI font generation system 1902. These processes include, for example, glyph processing 108, processing the set of input characters 1906, a finetuned AI model 1910 processing output of the glyph processing 1908, and vectorization 1912 which processes the output of the finetuned AI model 1910. The vectorization 1912 results in providing the output glyphs to a glyph application for presentation to a user, e.g., on a display of a user device.

In some implementations, each of the glyph processing 1908, the finetuned AI model 1910, and the vectorization 1912 can include one or more functions. The functions for the glyph processing 1908 can include, for example, a glyphs application 2002, an input vector glyphs 2004, a function to add spacing for input glyphs 2006, and a glyph application plugin 2008. For example, the glyph application plugin 2008 is a software tool that adds additional functionality to the glyph application. The functions for vectorization can include, for example, vectorization using raster to vector function 2018, extract spacing data from a predicted images function 2020, package vector outlines into a font function 2022, vector refitting function 2024, apply scale and translate function 2026, and export to glyphs application function 2028.

At 2002, the AI font generation system 1902 presents a glyphs application. A glyph, which is a specific shape, design, or representation of a character, can be input or created using a glyphs application. In particular, the glyphs application can be a software application that allows users to draw, edit, and test characters, manage font production, and extend various functionality of font creation to plugins and other scripts. The glyphs application can also retrieve glyphs from the glyph database 1904 for producing and creating other fonts.

In some cases, the glyphs application can be presented on a user device, e.g., a tablet, a personal computer, or a mobile device. The glyphs application can be accessed through a browser over the Internet or downloaded from the Internet to the user device. A user can interact with the glyphs application through a touchscreen, a mouse and keyboard setup, a stylus, or another type of input.

At 2004, a user can input one or more glyphs as vectors. The one or more glyphs can be included as vector representations. The vector representations can include one or more points, one or more vectors of the glyphs, and other representations that connect to together to form the glyph. These vectors or attributes can be sized and scaled according to their scalar data, vector magnitude, and their corresponding direction.

At 2006, the user can provide spacing data for the input glyphs through the glyphs application. In particular, the user can input spacing data into the glyphs application that includes left-side bearing and right-side bearing. The left-side bearing includes one or more points of spaces to the left of a glyph. Similarly, the right-side bearing includes one or more points of spaces to the right of a glyph.

In this manner, the left-side bearing, and the right-side bearing prevent the glyph being processed from overlapping with other glyphs. Moreover, the addition of spacing data makes the glyphs more visually appealing to the user. Similarly, the left-side bearing and the ride-side bearing ensure that the other glyphs do not overlap with the glyph being processed. For example, without spacing, the tail on a capital letter “Q” may overlap with another letter “u” in the word “Quit.”

In some cases, the user can also provide spacing data above the glyphs, e.g., numbers, letters, etc., and below the glyphs. This spacing may distinguish characteristics of a letter, such as providing a space between the tittle and the letter below it in the “i.” As another example, some stylistic fonts can include glyphs that frequently overlap, which can be corrected by the user. In this manner, a user can add spacing to each letter to prevent overlap in subsequent letters in a particular word. The spacing data may be stored in the glyph database 1904 with the font genome.

At 2008, the glyphs application can provide a plugin that can be used by the developer. In some implementations, a plugin is software that can extend the application's functionality, provide new tools not typically offered by the application, features, or other functionalities to enhance the font design workflow. For example, the plugins can include a filter plugin, a palette plugin, and one or more tool plugins.

As illustrated in FIG. 20, the plugin can include functions that relate to converting the vector glyph into one or more different representations to provide as input to a finetuned AI model. As will be further described below, the finetuned AI model 1910 can process the vector as the one or more different representations and output a set of characters to provide to the glyphs app in a designated font.

At 2010, the plugin function of the glyph application can generate a raster image of the vector representation of the glyphs. A raster image is a digital image that is composed of a grid of tiny, colored squares, such as pixels. Each pixel in the raster image can contain color and brightness information. In some cases, the raster image is a black and white image. The quality of the raster image can vary depending on the number of pixels in each image.

The input to the finetuned AI model 1910 operates on raster images. Accordingly, each of the input glyphs provided in 2002 and adjusted for spacing in 2006 is rasterized. The finetuned AI model 1910 generates a raster image for each of the input glyphs. However, to ensure that the finetuned AI model 1910 can process each of the input glyphs as raster images, the AI font generation system 1902 ensures that there is ample spacing in the raster images to distinguish these characters and to avoid any overlap.

At 2012, the AI font generation system 1902 adds spacing data to each of the input raster images. The spacing data in 2012 is required for the input raster images in addition to the spacing data provided in 2006. Here, the AI font generation system 1902 adds spacing data to each of the input raster images to ensure the output from the finetuned AI model also includes spacing data for the output characters.

The spacing data can be added automatically, such as through the use of one or more lines to the left and right of each the characters in the raster image data, or added as extra points to the left and right of each the characters in the raster image data. In some cases, the AI font generation system 1902 can add spacing data as metadata to each of the raster images. The metadata can include the pixels where spaces or lines are to be included in the raster images. In this manner, the finetuned AI model can process the raster image and/or the metadata of the raster image to correctly produce output characters with the spacing data.

Moreover, by including spacing data in the raster images, the finetuned AI model 1910 will improve its prediction capabilities. For example, the finetuned AI model 1910 can learn, through the analysis of a raster image for a particular letter, how to create a raster image of another letter, such as producing the letter “V” from the letter “A”. In this manner, the finetuned AI model 1910 can generate a set of character of an alphabet in a particular font from a single character alone.

At 2014, the AI font generation system 1902 can provide the raster images as input to the finetuned AI model 1910. The AI font generation system 1902 can process the rasterized images, analyze their features, and generate or predict output raster images for all characters. The input rasterized images can be of any size as specified by the glyphs application in 202.

The finetuned AI model 1910 can have any appropriate machine learning architecture, e.g., a neural network, which can be configured to process an input of one or more font glyphs to generate at least the remaining glyphs of the font. In particular, the finetuned AI model 1910 can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

In particular, the finetuned AI model 1910 can be implemented as any appropriate generative neural network. For example, the finetuned AI model 1910 can be or can include a stable diffusion machine learning model that has been configured to generate a high-quality image by updating a noisy image to match the intended image according to the data included in the rasterized image. More specifically, the stable diffusion machine learning model can be configured to sequentially refine an initial state representing the rasterized image through a sequence of transformations that add noise to a data sample to generate the output rasterized image.

At 2016, the finetuned AI model 1910 can generate an output of a raster image for all glyphs in the font using the input raster images. For instance, the finetuned AI model 1910 can output all characters in a particular font from the input, including lowercase letters “a” through “z” and upper-case letters “A” through “Z”. In some cases, the finetuned AI model 1910 can generate characters in one or more alphabets, e.g., for English, French, Greek, Russian, etc. languages. In some cases, the characters can also include numbers and symbols in the particular font from the input raster images. The AI font generation system 1902 can store these output raster images in a database for future training, for example. In some examples, the output of the rasterized image can be of size 512 pixels by 512 pixels.

At 2018, the AI font generation system 1902 can initiate the vectorization process. Specifically, the AI font generation system 1902 can vectorize the rasterized images output by the finetuned AI model 1910. The vectorization of the rasterized images includes performing edge detection on the output pixels, path creation of the pixels in the rasterized images to create vector files of the output glyphs, and other functions.

At 2020, the AI font generation system 1902 can extract spacing from the predicted images. The spacing can include the spacing that was incorporated at 2012. For example, the AI font generation system 1902 can remove lines from the output raster image, pixels of spaces from the output raster image, and metadata from the output raster image that describes the spacing in the corresponding output raster image.

At 2022, in response to extracting the spacing data from the output raster image, the AI font generation system 1902 can package the vector outlines into a font. The packaging of vector outlines into a font includes the process of instantiating each character in vector format output from the finetuned AI model 1910. This includes ensuring the font of each character can be scaled according to any size without losing clarity or quality, such as without becoming pixelated when used in a large font size. As a result, the AI font generation system 1902 generates a package of characters in vector format, each character presented in a font matching to the particular font of the input characters.

At 2024, the AI font generation system 1902 can perform a vector refitting process. In some cases, the output of the vectorization in 2018 may produce errors. The errors can include, for example, one or more additional points, a misalignment of one or more of the output glyphs, an incorrect rotation of one or more of the output glyphs, a scaling inconsistency across each of the output glyphs, and other inconsistencies noted across the output characters. The AI font generation system 1902 can automatically analyze each of the glyphs output in vector form to detect any one of these errors. If the AI font generation system 1902 does not detect an error in the output vectors, then the process proceeds to 2026. If one or more errors are detected, then the AI font generation system 1902 can automatically correct the detected errors.

At 2026, the AI font generation system 1902 can scale and translate the vectorized glyphs. The vectorized glyphs are scaled and translated to the same format as applied to the input vector glyphs. In this manner, the size and shape of the output vectorized glyphs can match to the size and shape of the vectorized glyphs in 2004.

At 2028, the AI font generation system 1902 outputs the resultant vectorized glyphs to the glyphs application 2002. The glyphs application can display the resultant vectorized glyphs showing all the characters in the particular font matching to the particular font from the input glyphs.

FIG. 21 illustrates a creation of a new font from a target font through process 2100. The process 2100 illustrates different components that work collectively to create a new font from a target font for a particular letter. The process 2100 may be performed by the AI font generation system 1902.

The process 2100 illustrates a generative artificial intelligence pipeline that seeks to convert a source image with a base font to a target image using one or more reference images, where both the target image and the one or more reference images illustrate a target font. The target image and the one or more reference images are illustrated in the same font type, and the source image is shown in a different font type. The process 2100 attempts to learn the process of converting the source image into the target image using various encoders and a stable diffusion model, e.g., a U-Net. The process 2100 can be performed in a training environment and a deployed, e.g., inference, environment. During deployment, the path includes the target image 2112, the encoder 2116, the latent 2118, the noise 2120, the noisy latent 2122, the scheduler 2126, and the loss 2130 are not used, since the deployed U-Net is trained.

In some implementations, the process 2100 may be executed in response to feedback provided by a user that a particular character does not match a desired font. The AI font generation system 1902 can attempt to match the particular character to the desired font in the reference images 2104 using the process described below.

As illustrated in FIG. 21, a dataset 2102 can include the reference images 2104, the source image 2110, and the target image 2112. The AI font generation system 1902 may retrieve the dataset 2102 from the glyph database 1904. The AI font generation system 1902 may provide the reference images 2104 to a style encoder 2106, the source image 2110 to a structure encoder 2114, and the target image 2112 to an encoder 2116. For example, as illustrated in FIG. 21, the reference images 2104 includes the words “HamburgeFONT”, the source image 2110 includes a letter “K” in an initial font, and the target image includes a letter “K” in a desired font.

The style encoder 2106 receives the reference images 2104 and converts the reference images 2104 into a first embedding. The first embedding is a representation of the reference images 2104 in a particular dimensionality. The structure encoder 2114 receives the source image 2110 and converts the source image 2110 into a second embedding. Similar to the first embedding, the second embedding is a representation of the source image 2110 in a particular dimensionality. Similarly, the encoder 2116 can be a variational autoencoder. The encoder 2116 converts the target image 2112 into an embedding, but captures fine details of the target image 2112 to generate a high dimensional embedding output by the encoder 2116.

In some implementations, the style encoder 2106 determines the font of the reference images 2104. Based on the determined font, the style encoder 2106 outputs a representation of the font of the reference images 2104 in the form of a first embedding or a style embedding. The first embedding may be, for example, a 128-dimensional value.

In some implementations, the structure encoder 2114 can determine the structure of the character in the source image 2110. For example, the structure encoder 2114 determines the structure of the letter “K” in the source image 2110 and outputs a representation of the structure in the form of the second embedding or a structure embedding. The second embedding may be, for example, a 128-dimensional value.

The AI font generation system 1902 can combine the style embedding and the structure embedding to generate a context embedding 2108. In some cases, the context embedding 2108 can include a concatenation of the style embedding and the structure embedding. In some cases, the context embedding 2108 include a merged version of the style embedding and the structure embedding. The merged version of the style embedding and the structure embedding may be combined using summation, XOR'ing, or another type of merger. The AI font generation system 1902 provides the context embedding to the U-Net 324.

In some cases, if the context embedding 2108 is created through concatenation, then no embedding information is lost and the U-Net 2124 has more information from the output embedding to process. However, the U-Net 2124 will require more time to process the concatenated embedding, which will improve the overall accuracy of the U-Net 2124 but, in some cases, can reduce the speed at which the AI font generation system 1902 processes.

In some cases, if the context embedding 2108 is created through merging, then some embedding information may be lost in the process and the U-Net 2124 may have less information to process. However, the U-Net 2124 will require less time to train because the size of the merged context embedding 2108 is smaller than the concatenated version of the context embedding 2108. The accuracy of the U-Net 2124 may also be less because since information is lost by aggregating the embeddings, e.g., relative to using the concatenated output embedding.

In some implementations, the encoder 2116 processes the target image 2112 to ensure the output at the end of the process 2100 matches to the font shown in the target image 2112. However, during deployment, the path that utilizes the target image 2112, the encoder 2116, the latent 2118, the noise 2120, the noisy latent 2122, the scheduler 2126, and the loss 2130 is not used. This path is only used during training.

In some implementations, the generative artificial intelligence model 2124 can include a U-Net. The U-Net is a latent diffusion model that includes an encoder block to map images to a lower-dimensional latent space before applying the sequence of transformations and a decoder block to map from the lower-dimensional latent space back into image space. For instance, the U-Net 2124 includes skip connections that allow the model to combine both coarse features from the beginning of the sequence of transformations and fine features from the end of the sequence of transformations to improve the generated image quality. In some implementations, the U-Net 2124 receives and processes the context embedding 2108.

During training, the U-Net 2124 can receive information output by the encoder 2116. The output by the encoder 2116 is delayed by a latent 2118, a noise 2120, and summed and provided to the U-Net 2124.

In some implementations, the U-Net 2124 can output an encoded representation of the output as an image. The encoded representation of the output as the image can be provided through a latent 2138 and to a decoder 2132. The latent 2138 can create an encoding of the image output by the U-Net 2124. The decoder 2132 can decode the letter output by the U-Net 2124, and provide the letter as output 2134. Accordingly, the output 2134 showing the letter “K” can match to the font shown in the reference images 2104 and the font shown in the target image 2112. During training, the U-Net 2124 may provide loss data 2130 to the noise 2120 and receive a time embedding through the scheduler 2126. The time embedding may be helpful in training the U-Net 2124 using input embeddings.

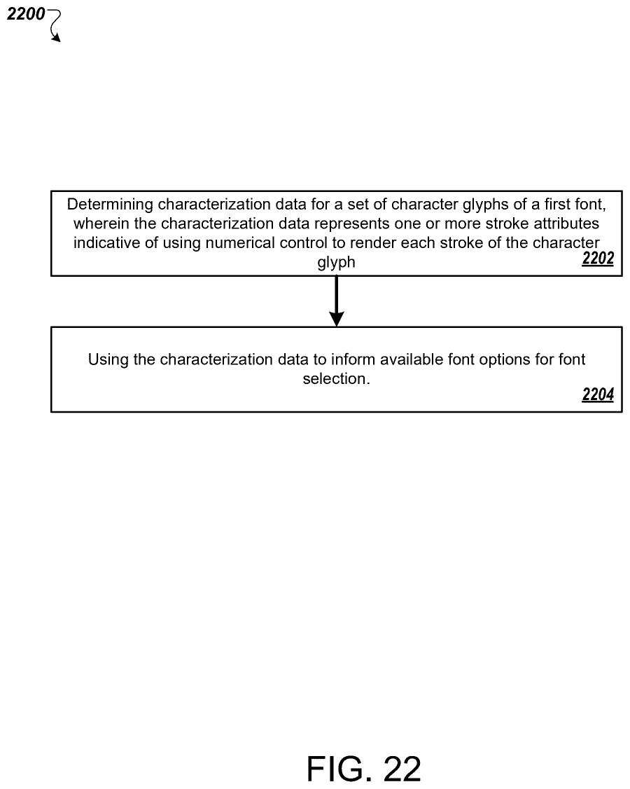

FIG. 22 is a flow diagram that illustrates an example of a process 2200 for determining a font genome dataset. The server 102 can perform the process 2200.

The server can determine characterization data for a set of character glyphs for a first font (2202). The characterization data represents one or more stroke attributes indicative of using numerical control to render each stroke of the character glyph. In particular the server can define one or more keypoints for each character glyph and characterize one or more stokes by determining a set of attributes for each keypoint using an image classification model.

In some cases, the server can define the one or more keypoints for each character glyph by processing each character glyph using an image correspondence model to determine the one or more keypoints. The one or more keypoints determined by the image correspondence model are generalizable. Specifically, the server defines the one or more keypoints for each character glyph by identifying a bounding box relative to a cardinal direction on the character glyph and advancing or traversing in a direction from a selected point along a contour of each stroke in a set of strokes in the bounding box until one or more criteria are met. In response, the server can define the one or more key points in accordance with the criteria each contour of each stroke meets in the bounding box. The one or more criteria met include one or more of width, angle, or rate of change criteria. The server can measure an angle of each contour of each stroke relative to the closest perpendicular stroke to the contour.

In some cases, the server can group character glyphs into logical groups based on the determined stroke attributes. The server can evaluate a measure of distance between the defined one or more keypoints.

The server can use the characterization data to inform available font options for font selection (2204). In some implementations, the server can determine characterization data for a plurality of fonts. In response, the server generates a font genome by aggregating the determined characterization data for the plurality of fonts and the determined characterization for the set of character glyphs of the first font.

In some cases, the server uses the characterization data to inform search engine results. The server can use the characterization data to inform available options for font selection further includes conditioning a machine learning model for font selection using embeddings of the characterization data. The server can condition a generative machine learning model to generate fonts using the embeddings of the characterization data.

In some implementations, the server can receive font genome data for a subset of character glyphs in a font, the font genome data includes characterization data for each character glyph in the subset. The server can condition a generative machine learning model to generate fonts using the font genome data for the subset of character glyphs in the font. In response, the server can generate a font comprising a set of character glyphs not in the subset of character glyphs in the font.

In some cases, conditioning the generative machine learning model to generate fonts using the font genome data includes using embeddings of the characterization data. The generative machine learning model can include a stable diffusion model. In some cases, the server can integrate the characterization embeddings into an embedding layer of the stable diffusion model. The server can receive one or more control parameters indicative of desired font characteristics when conditioning the generative machine learning model to generate fonts using the font genome data.

In some cases, the subset of character glyphs in the font is representative of a mutually exclusive subset of character glyphs in the font. In some cases, the server generates the font genome data for the subset of character glyphs in the font.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor. The programmable processor can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a device for displaying data to the user (e.g., a CRT (cathode ray tube) or LCD (liquid crystal display) monitor), and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a backend component (e.g., as a data server), or that includes a middleware component (e.g., an application server), or that includes a frontend component (e.g., a client computer having a user interface or a Web browser through which a user can interact with an implementation of the systems and techniques described here), or a combination of such back end, middleware, or frontend components. The components of the system can be interconnected by a form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the engines described herein can be separated, combined, or incorporated into a single or combined engine. The engines depicted in the figures are not intended to limit the systems described here to the software architectures shown in the figures.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

1. A computer-implemented method comprising:
determining characterization data for a set of character glyphs of a first font, wherein the characterization data represents one or more stroke attributes indicative of using numerical control to render each stroke of the character glyph; and
using the characterization data to inform available font options for font selection.

2. The computer-implemented method of claim 1, further comprising:
determining characterization data for a plurality of fonts; and
generating a font genome by aggregating the determined characterization data for the plurality of fonts and the determined characterization for the set of character glyphs of the first font.

3. The computer-implemented method of claim 1, wherein determining characterization data comprises:
defining one or more keypoints for each character glyph; and
characterizing one or more strokes by determining a set of attributes for each keypoint using an image classification model.

4. The computer-implemented method of claim 3, wherein defining the one or more keypoints for each character glyph comprises processing each character glyph using an image correspondence model to determine the one or more keypoints.

5. The computer-implemented method of claim 4, wherein the one or more keypoints determined by the image correspondence model are generalizable.

6. The computer-implemented method of claim 3, wherein defining the one or more keypoints for each character glyph comprises:
identifying a bounding box relative to a cardinal direction on the character glyph;
advancing in a direction from a selected point along a contour of each stroke in a set of strokes in the bounding box until one or more criteria are met; and
defining the one or more key points in accordance with the criteria each contour of each stroke meets in the bounding box.

7. The computer-implemented method of claim 6, wherein the one or more criteria met comprise one or more of width, angle, or rate of change criteria.

8. The computer-implemented method of claim 6, further comprising measuring an angle of each contour of each stroke relative to a closest perpendicular stroke to the contour.

9. The computer-implemented method of claim 3, further comprising grouping character glyphs into logical groups based on the determined stroke attributes.

10. The computer-implemented method of claim 3, further comprising evaluating a measure of distance between the defined one or more keypoints.

11. The computer-implemented method of claim 1, wherein using the characterization data to inform available font options for font selection further comprises using the characterization data to inform search engine results.

12. The computer-implemented method of claim 1, wherein using the characterization data to inform available font options for font selection further comprises conditioning a machine learning model for font selection using embeddings of the characterization data.

13. The method of claim 12, wherein using the characterization data to inform available font options for font selection further comprises conditioning a generative machine learning model to generate fonts using the embeddings of the characterization data.

14. A system comprising one or more computer and one or more storage devices storing instructions that are operable, when executed by the one or more computers, to cause the one or more computers to perform operations comprising:
determining characterization data for a set of character glyphs of a first font, wherein the characterization data represents one or more stroke attributes indicative of using numerical control to render each stroke of the character glyph; and
using the characterization data to inform available font options for font selection.

15. A computer storage medium encoded with a computer program, the program comprising instructions that are operable, when executed by a data processing apparatus, to cause the data processing apparatus to perform operations comprising:
determining characterization data for a set of character glyphs of a first font, wherein the characterization data represents one or more stroke attributes indicative of using numerical control to render each stroke of the character glyph; and
using the characterization data to inform available font options for font selection.

16. A computer-implemented method comprising:
receiving font genome data for a subset of character glyphs in a font, wherein the font genome data comprises characterization data for each character glyph in the subset;
conditioning a generative machine learning model to generate fonts using the font genome data for the subset of character glyphs in the font; and
generating a font comprising a set of character glyphs not in the subset of character glyphs in the font.

17. The computer-implemented method of claim 16, wherein conditioning the generative machine learning model to generate fonts using the font genome data comprises using embeddings of the characterization data.

18. The computer-implemented method of claim 17, wherein the generative machine learning model comprises a stable diffusion model, and wherein conditioning the stable diffusion model using the embeddings of the characterization data further comprises:
integrating the characterization embeddings into an embedding layer of the stable diffusion model.

19. The computer-implemented method of claim 18, wherein conditioning the generative machine learning model to generate fonts using the font genome data further comprises receiving one or more control parameters indicative of desired font characteristics.

20. The computer-implemented method of claim 19, wherein the subset of character glyphs in the font is representative of a mutually exclusive subset of character glyphs in the font.

21. The computer-implemented method of claim 20, further comprising generating the font genome data for the subset of character glyphs in the font.

22. A system comprising one or more computer and one or more storage devices storing instructions that are operable, when executed by the one or more computers, to cause the one or more computers to perform operations comprising:
receiving font genome data for a subset of character glyphs in a font, wherein the font genome data comprises characterization data for each character glyph in the subset;
conditioning a generative machine learning model to generate fonts using the font genome data for the subset of character glyphs in the font; and
generating a font comprising a set of character glyphs not in the subset of character glyphs in the font.

23. A computer storage medium encoded with a computer program, the program comprising instructions that are operable, when executed by a data processing apparatus, to cause the data processing apparatus to perform operations comprising:
receiving font genome data for a subset of character glyphs in a font, wherein the font genome data comprises characterization data for each character glyph in the subset;
conditioning a generative machine learning model to generate fonts using the font genome data for the subset of character glyphs in the font; and
generating a font comprising a set of character glyphs not in the subset of character glyphs in the font.

24. A method comprises:
receiving data representing an input character glyph associated with a particular font;
generating first spacing data indicative of a spacing proximate to the input character glyph associated with the particular font;
generating first image data comprising the data representing the input character glyph associated with the particular font and the generated first spacing data;
generating second spacing data indicative of a spacing proximate to the input character glyph in the generated first image data;
providing, as input to a machine learning model, the generated first image data and the generated second spacing data;
obtaining, as output from the machine learning model, second image data of a set of output character glyphs associated with the particular font;
generating a vector format of the obtained second image data of the set of output character glyphs;
extracting the second spacing data from the generated vector format of the set of output character glyphs;
scaling the generated vector format to match to a form of the data representing the input character glyph; and
providing the scaled vector format of the set of output character glyphs for output, wherein the scaled vector format comprises the set of output character glyphs associated with the particular font.
